(19) United States
(12) Patent Application Publication
(10) Pub. No.: US 2025/0100799 A1
(43) Pub. Date: Mar. 27, 2025

(54) GOODS BOX STORAGE METHOD AND ROBOT

(71) Applicant: BEIJING GEEKPLUS TECHNOLOGY CO., LTD., Beijing (CN)

(72) Inventors: Zewei LI, Beijing (CN); Yuefan HAO, Beijing (CN); Hongbo LI, Beijing (CN)

(73) Assignee: BEIJING GEEKPLUS TECHNOLOGY CO., LTD., Beijing (CN)

(21) Appl. No.: 18/730,727

(22) PCT Filed: Feb. 8, 2023
(86) PCT No.: PCT/CN2023/075054

§ 371 Date: Jul. 19, 2024

(30) Foreign Application Priority Data
Feb. 11, 2022 (CN) 202210130228.7
Jun. 30, 2022 (CN) 202210778425.X

(51) Int. Cl. B65G 1/137; B65G 61/00

(52) U.S. Cl. CPC B65G 1/137; B65G 61/00; B65G 2203/044

(57) ABSTRACT

A goods box storage method and a robot. The goods box storage method includes: controlling, based on a preset storage location of a target goods box, a robot to move to a preset location of the robot; detecting a target marker to which the target goods box belongs, the target marker being a structural feature of at least one of a target shelving unit to which the target goods box belongs, a goods box adjacent to the target goods box, and a goods box on a shelving unit opposite to the target shelving unit; determining a target storage location of the target goods box on the target shelving unit based on a location of the target marker; and controlling, based on the target storage location, the robot to move from the preset location of the robot to store the target goods box on the target shelving unit.

### CROSS-REFERENCE TO RELATED APPLICATIONS

This application claims priority to Chinese Patent Application No. 202210130228.7, filed with the China National Intellectual Property Administration on Feb. 11, 2022 and entitled “GOODS BOX STORAGE METHOD AND ROBOT” and Chinese Patent Application No. 202210778425.X, filed with the China National Intellectual Property Administration on Jun. 30, 2022 and entitled “CONTAINER LOCATING METHOD AND APPARATUS, CONTAINER STORAGE AND RETRIEVAL DEVICE, AND STORAGE MEDIUM”, which are incorporated herein by reference in their entireties.

### TECHNICAL FIELD

The present invention relates to the field of warehousing technologies, and in particular, to a goods box storage method and a robot.

### BACKGROUND

A mobile robot (AGV) is an automated guided vehicle that automatically travels to a specified place based on a planned path. In the related art, the mobile robot uses an information collection apparatus thereof such as a camera to identify an identifier (such as a QR code) on goods or a shelving unit to implement goods locating and docking.

However, inventors of the present invention realized that, to implement the foregoing docking manner, a location of a goods location needs to be planned in advance before the mobile robot is formally deployed, and the identifier is accurately attached to a goods box and the shelving unit. In addition, the goods location is in a one-to-one correspondence with the identifier. When a relatively large quantity of goods locations are provided, more identifiers need to be attached, which is cumbersome to implement and has high implementation costs and safety guarantee costs. In addition, the shelving unit is regularly maintained and upgraded, and the identifier is reattached, which further increases the costs.

### SUMMARY

In view of this, an embodiment of the present invention provides a goods box storage method. According to the method, an identifier does not need to be attached to a goods box or a shelving unit in advance, so that costs are saved.

An embodiment of the present invention further provides a robot.

The goods box storage method in this embodiment of the present invention includes:
controlling, based on a preset storage location of a target goods box, a robot to move to a preset location of the robot;
detecting a target marker to which the target goods box belongs, the target marker being a structural feature of at least one of a target shelving unit to which the target goods box belongs, a goods box adjacent to the target goods box, and a goods box on a shelving unit opposite to the target shelving unit;
determining a target storage location of the target goods box on the target shelving unit based on a location of the target marker; and
controlling, based on the target storage location, the robot to move from the preset location of the robot to store the target goods box on the target shelving unit.

According to the goods box storage method in this embodiment of the present invention, the target storage location (an accurate storage location) of the target goods box is determined by using an existing shelving unit or another goods box placed on the shelving unit in a warehousing operation scene as the target marker. Since the target marker no longer adopts the identifier such as a QR code that needs to be attached in advance, according to the goods box storage method in this embodiment of the present invention, the identifier does not need to be attached in advance, which not only saves the labor time, but also reduces implementation costs.

In some embodiments, the detecting the target marker to which the target goods box belongs includes:
detecting a code pattern on the target shelving unit to which the target goods box belongs; and
detecting the target marker to which the target goods box belongs in a case that the code pattern is not detected.

In some embodiments, the goods box storage method further includes:
determining the target storage location of the target goods box on the target shelving unit based on a location of the code pattern in a case that the code pattern is detected.

In some embodiments, the robot includes a robot body and a retrieval and storage mechanism arranged on the robot body. The controlling, based on a preset storage location of a target goods box, a robot to move to a preset location of the robot includes: controlling the robot body to move to a first horizontal location, and controlling the retrieval and storage mechanism to move to a first height location.

In some embodiments, the retrieval and storage mechanism is controlled to move to the first height location after the robot body moves to the first horizontal location or when the robot body is moving toward the first horizontal location, or the retrieval and storage mechanism is controlled to move to a second height location lower than the first height location before the robot body moves to the first horizontal location, and the retrieval and storage mechanism is controlled to move from the second height location to the first height location after the robot body is moved to the first horizontal location.

In some embodiments, after the robot moves to the preset location of the robot or when the robot is moving toward the preset location of the robot, the target storage location is determined based on the location of the target marker.

In some embodiments, during detection of the target marker, a box placement task is canceled if the target marker does not match a preset box storage feature or the target marker is not detected.

In some embodiments, the goods box storage method further includes: detecting whether there is another goods box on the target storage location, and transmitting, to a server, information that another goods box exists on the target storage location if there is another goods box; and controlling the robot to cancel a box placement task, or reassigning a storage location to the target goods box, or controlling the robot to retrieve the another goods box and place the another goods box in another location.

In some embodiments, the goods box storage method further includes: detecting an actual placement location of the target goods box after the target goods box is placed on the target shelving unit; and comparing the actual placement location with the target storage location and determining a relative location error of the actual placement location relative to the target storage location, and controlling the robot to retrieve the target goods box and relocate the target goods box if the relative location error does not satisfy a preset error condition.

In some embodiments, the goods box storage method further includes: detecting space occupation information of the target shelving unit and transmitting the space occupation information of the target shelving unit to a server after the target goods box is placed on the target shelving unit.

In some embodiments, when a first target goods box is placed on the target shelving unit, the target marker is a structural feature of the target shelving unit.

The robot of this embodiment of the present invention includes: a robot body; a retrieval and storage mechanism, arranged on the robot body; a control unit, configured to control, based on a preset storage location of a target goods box, the robot to move to a preset location of the robot; and a detection unit, arranged on the retrieval and storage mechanism and configured to detect a target marker to which the target goods box belongs. The target marker is a structural feature of at least one of a target shelving unit to which the target goods box belongs, a goods box adjacent to the target goods box, and a goods box on a shelving unit opposite to the target shelving unit. The control unit is further configured to determine a target storage location of the target goods box based on a location of the target marker, and control, based on the target storage location, the robot to move to cause the retrieval and storage mechanism to store the target goods box on the target shelving unit.

According to the robot of this embodiment of the present invention, the target storage location (an accurate storage location) of the target goods box may be determined by using an existing shelving unit or another goods box placed on the shelving unit in a warehousing operation scene as the target marker. Since the target marker no longer adopts the identifier such as a QR code that needs to be attached in advance, according to the present invention, the identifier does not need to be attached in advance, which not only saves the labor time, but also reduces implementation costs.

In some embodiments, the detection unit is configured to detect a code pattern on the target shelving unit to which the target goods box belongs, and detect the target marker to which the target goods box belongs in a case that the code pattern is not detected.

In some embodiments, the control unit is configured to determine the target storage location of the target goods box on the target shelving unit based on a location of the code pattern in a case that the detection unit detects the code pattern.

In some embodiments, the control unit is configured to control, based on a preset storage location of the target goods box, the robot body to move to a first horizontal location, and control the retrieval and storage mechanism to move to a first height location.

### BRIEF DESCRIPTION OF THE DRAWINGS

FIG. 1 is a flowchart of a goods box storage method according to an embodiment of the present invention.

FIG. 2 is a schematic diagram of a state of a robot according to an embodiment of the present invention during operation.

FIG. 3 is a schematic structural diagram of a robot according to an embodiment of the present invention.

FIG. 4 is a flowchart of a goods box storage method according to an embodiment of the present invention.

FIG. 5 is a schematic diagram of a front end contour of a target marker according to an embodiment of the present invention.

FIG. 6 is a projection view of a target marker according to an embodiment of the present invention.

FIG. 7 is a flowchart of a goods box locating method according to an embodiment of the present invention.

FIG. 8 is a schematic structural diagram of a goods box storage apparatus according to an embodiment of the present invention.

FIG. 9 is a structural block diagram of a goods box storage and retrieval device according to an embodiment of the present invention.

### REFERENCE NUMERALS

Robot 100; Robot body 110; Retrieval and storage mechanism 120; Control unit 130; Detection unit 140; Image capture apparatus 141; Image processing apparatus 142; Target shelving unit 200; Post 210; Shelf 220; Transverse beam 230; Subspace 240.

### DETAILED DESCRIPTION

Embodiments of the present invention are described in detail below, and examples of the embodiments are shown in the accompanying drawings. The embodiments described below with reference to the accompanying drawings are exemplary, and are intended to explain the present invention, but cannot be construed as a limitation on the present invention.

A goods box storage method of the embodiments of the present invention is described below with reference to the accompanying drawings. In a warehousing operation scene, a robot may run in a storage region. The storage region is provided with shelving units, and the robot may retrieve and place goods boxes from different layers/different compartments of the shelving units.

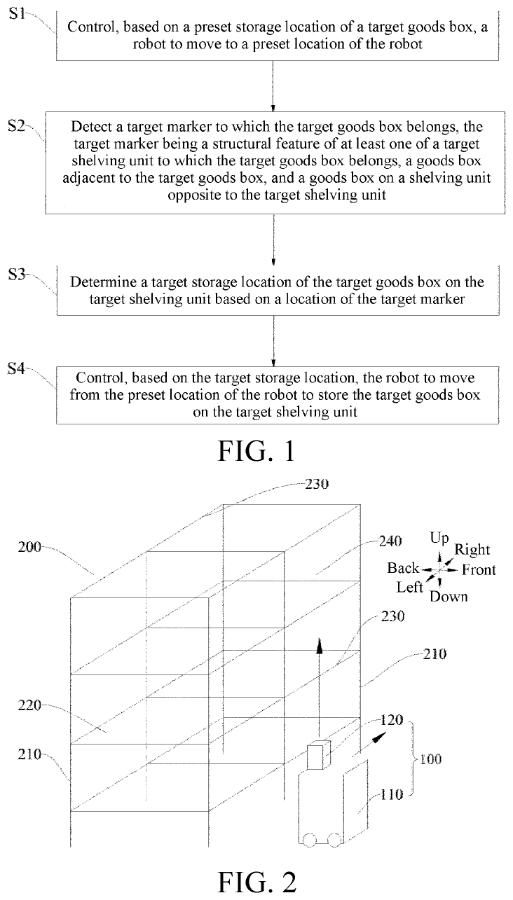

As shown in FIG. 1, the goods box storage method of this embodiment of the present invention includes the following steps.

S1: Control, based on a preset storage location of a target goods box, a robot to move to a preset location of the robot. Specifically, a dispatching system sends preset storage location information of the target goods box, and a robot 100 receives the preset storage location information and carries the target goods box to navigate to travel based on the preset storage location information. When the robot 100 travels to the preset location of the robot, the robot 100 stops traveling. It may be understood that the preset storage location of the target goods box is a rough storage location of the target goods box and not an accurate storage location. The robot 100 first reaches the preset location of the robot based on the rough storage location of the target goods box.

S2: Detect a target marker to which the target goods box belongs, the target marker being a structural feature of at least one of a target shelving unit 200 to which the target goods box belongs, a goods box adjacent to the target goods box, and a goods box on a shelving unit opposite to the target shelving unit 200.

In other words, in some optional embodiments, the target marker is a structural feature of the target shelving unit 200. Specifically, the shelving unit includes a transverse beam 230, a post 210, and a shelf 220. The shelf 220 is configured for the goods box to be placed. The post 210 and the transverse beam 230 are configured to support the shelf 220. As shown in FIG. 2, the post 210 extends in an up-down direction, a plurality of posts 210 are located on outer edges of the shelving unit and are arranged at intervals in a circumferential direction of the shelving unit, and the transverse beam 230 extends in a left-right direction and is connected to the post 210. A plurality of transverse beams 230 are arranged in a plurality of columns at intervals in a front-rear direction. Each column includes several transverse beams 230 arranged at intervals in the up-down direction. The shelf 220 extends in the front-rear direction and is arranged between adjacent columns of the transverse beams 230 and connected to the transverse beams 230 and/or the posts 210. A plurality of shelves 220 are arranged at intervals in the up-down direction and the plurality of transverse beams 230 are arranged at intervals in the up-down direction so as to form a plurality of storage spaces in a space defined by the plurality of posts 210. The plurality of posts 210 include at least three posts 210 arranged at intervals in the left-right direction. The remaining posts located between a leftmost post and a rightmost post may partition the storage space into a plurality of subspaces 240 arranged at intervals in the left-right direction. One or more goods boxes may be stored in each subspace 240. The structural feature of the target shelving unit 200 may be coordinate values of a specific location of the post 210, or coordinate values of a specific location of the transverse beam 230, or coordinate values of a specific location of the shelf 220. The specific location on the post 210, the transverse beam 230, and the shelf 220 may be determined based on a specific situation.

In some other optional embodiments, the target marker is a structural feature of the goods box adjacent to the target goods box. It is to be noted that the goods box adjacent to the target goods box is a goods box already existing in the target shelving unit 200, and may be adjacent to the target goods box in the front-rear direction. For example, at least two goods boxes, i.e., a rear goods box and a front goods box, may be placed in the same subspace 240. The rear goods box is first placed, and then the front goods box is placed. During placement of the front goods box, the rear goods box may be used as a target marker. The goods box may also be adjacent to the target goods box in the left-right direction. For example, one goods box is placed in each of adjacent subspaces 240. The goods box corresponding to one subspace 240 is first placed, and then the goods box corresponding to the other subspace 240 is placed. During placement of the goods box corresponding to the other subspace 240, the goods box corresponding to the foregoing subspace 240 may be used as a target marker. Specifically, the structural features of adjacent goods boxes may be coordinate values of a specific location of the goods box. The specific location may be determined based on a specific situation. More than one goods box may also be placed in the same subspace 240. If a goods box already exists in a subspace 240, the target goods box may use the goods box already existing in the subspace 240 as the target marker, and then the target goods box is placed.

In yet some optional embodiments, the target marker is the structural feature of the goods box adjacent to the target goods box and the structural feature of the target shelving unit 200. In other words, both the structural feature of the goods box adjacent to the target goods box and the structural feature of the target shelving unit 200 can be detected during detection.

In still some embodiments, the target marker is a structural feature of a goods box on a shelving unit opposite to the target shelving unit 200. Specifically, two rows of shelving units are opposite and arranged at intervals, and a passable aisle is formed between the two rows of shelving units. One row of shelving units is the target shelving unit 200. If there is no goods box on the target shelving unit 200, but there is a goods box on the other row of shelving units, structural features of goods boxes on the other row of shelving units may be detected.

In another embodiment, the target marker may also be the structural feature of the goods box adjacent to the target goods box and the structural feature of the goods box on the shelving unit opposite to the target shelving unit 200, or may be the structural feature of the target shelving unit 200 and the structural feature of the goods box on the shelving unit opposite to the target shelving unit 200.

In some embodiments, the detecting the target marker to which the target goods box belongs in a case that the target marker is a goods box includes: obtaining a goods box image obtained by capturing an image of the target marker by a vision sensor;
performing edge detection on the goods box image to determine a plurality of edge line intersection points of the target marker, and performing contour detection on the goods box image to determine a plurality of contour vertices of the target marker;
checking the plurality of edge line intersection points and the plurality of contour vertices to determine a target vertex of the target marker; and
determining the location of the target marker based on the target vertex.

In some embodiments, the performing edge detection on the goods box image to determine a plurality of edge line intersection points of the target marker includes:
performing edge detection on the goods box image to obtain a target edge detection image, where the target edge detection image includes a plurality of edge lines of the target marker in the goods box image; and
identifying intersection points of the plurality of edge lines in the target edge detection image as the plurality of edge line intersection points of the target marker.

In some embodiments, the performing edge detection on the goods box image to obtain a target edge detection image includes:
performing edge detection on the goods box image to obtain an initial edge detection image; and
fitting edge lines in the initial edge detection image to obtain the target edge detection image.

In some embodiments, the performing edge detection on the goods box image to obtain an initial edge detection image includes:

performing gradient calculation on the goods box image to obtain the initial edge detection image.

In some embodiments, the performing contour detection on the goods box image to determine a plurality of contour vertices of the target marker includes: performing contour detection on the goods box image to obtain a target contour detection image, where the target contour detection image includes a contour of the target marker in the goods box image; and
identifying vertices of the contour in the target contour detection image as a plurality of contour vertices of the target marker.

In some embodiments, the performing contour detection on the goods box image to obtain a target contour detection image includes:
performing contour detection on the goods box image to obtain an initial contour detection image; and
fitting contours in the initial contour detection image to obtain the target contour detection image.

In some embodiments, the performing contour detection on the goods box image to obtain an initial contour detection image includes:
performing binarization on the goods box image to obtain the initial contour detection image.

In some embodiments, the checking the plurality of edge line intersection points and the plurality of contour vertices to determine a target vertex of the target marker includes:
determining a first edge line intersection point and a first contour vertex at a same location;
obtaining pixel information of each first pixel point within a preset range of the first edge line intersection points and pixel information of each second pixel point within a preset range of the first contour vertices; and
determining the target vertex of the target marker based on the pixel information of each first pixel point and the pixel information of each second pixel point.

In some embodiments, the determining a first edge line intersection point and a first contour vertex at a same location includes:
identifying a preset identifier in the goods box image, where the preset identifier is arranged at each vertex of the target marker in advance;
calculating a first distance between each of the plurality of edge line intersection points and the preset identifier, and a second distance between each of the plurality of contour vertices and the preset identifier; and
determining, based on the first distance and the second distance, the first edge line intersection point and the first contour vertex at the same location.

In some embodiments, the determining the target vertex of the target marker based on the pixel information of each first pixel point and the pixel information of each second pixel point includes:
determining a first pixel gray level distribution within the preset range of the first edge line intersection points based on the pixel information of each first pixel point, and determining a second pixel gray level distribution within the preset range of the first contour vertices based on the pixel information of each second pixel point;
determining, from the first pixel gray level distribution and the second pixel gray level distribution, a target pixel gray level distribution that is consistent with a preset distribution rule; and
determining the target vertex of the target marker from the first edge line intersection point and the first contour vertex based on the target pixel gray level distribution.

In some embodiments, a contour shape of the target marker is a quadrilateral; and
the determining the location of the target marker based on the target vertex includes:
obtaining vertex information of any three target vertices from four target vertices of the target marker; and
calculating, based on the vertex information of the three target vertices, pose information of the target marker relative to the vision sensor by using a preset perspective projection algorithm.

In some embodiments, after the calculating, based on the vertex information of the three target vertices, pose information of the target marker relative to the vision sensor by using a preset perspective projection algorithm, the method further includes:
projecting a remaining target vertex among the four target vertices in addition to the three target vertices onto the goods box image based on the pose information, to obtain projection coordinates of the remaining target vertex;
obtaining vertex coordinates of the remaining target vertex in the goods box image;
calculating an error value based on the projection coordinates and the vertex coordinates;
updating the pose information based on the error value, and repeating the step of projecting the remaining target vertex among the four target vertices in addition to the three target vertices onto the goods box image based on the pose information, to obtain the projection coordinates of the remaining target vertex; and
determining that an updated pose information is target pose information of the target marker relative to the vision sensor in a case that the error value is less than or equal to a preset threshold.

In some embodiments, before the performing edge detection on the goods box image to obtain a plurality of edge line intersection points of the target marker, and performing contour detection on the goods box image to determine a plurality of contour vertices of the target marker, the method further includes:
performing filtering on the goods box image to obtain the goods box image with noise removed.

In some embodiments, the target marker is a goods box.

S3: Determine a target storage location of the target goods box on the target shelving unit 200 based on a location of the target marker. It may be understood that the target storage location is an accurate storage location of the target goods box. The accurate storage location is determined based on a location of a detected target marker.

In some embodiments, the coordinate values of specific locations of the target shelving unit 200 and the goods box are determined based on a preset space rectangular coordinate system. The coordinate values of each specific location of the target shelving unit 200 are pre-stored in a server of the dispatching system after construction of the target shelving unit 200 is completed. For example, a space rectangular coordinate system formed in the left-right direction, the up-down direction, and the front-rear direction is used as an example. The left-right direction is used as an X axis, the up-down direction is used as a Y axis, and the front-rear direction is used as a Z axis.

It is assumed that the coordinate values of the target marker are (x, y, z), coordinate values (X, Y, Z) of the target storage location may be calculated by using the following equation. For example, if the target marker is a goods box adjacent to a left side or a right side of the target goods box, for the coordinate value X of the target marker, X=x+a deviation value of the target goods box and the goods box as the target marker in the left-right direction. The deviation value may be, for example, a width of the target goods box/2+a width of the goods boxes adjacent to the target goods box/2+a spacing between adjacent goods boxes in the left-right direction. For the coordinate value Y of the target marker, if the target goods box and the goods box as the target marker correspond to the same transverse beam 230, i.e., which have a consistent height in the up-down direction, Y=y. If the target goods box and the goods box as the target marker correspond to different transverse beams 230, i.e., which have inconsistent heights in the up-down direction, Y=y+a deviation value of the target goods box and the goods box as the target marker in the up-down direction. The deviation value is, for example, a height of the target goods box/2+a height of the goods box adjacent to the target goods box/2+the spacing between adjacent goods boxes in the up-down direction. For the coordinate value Z of the target marker, if the location of the target goods box is consistent with that of the goods box as the target marker in the Z direction, Z=z. If the location of the target goods box is not consistent with that of the goods box as the target marker in the Z direction, Z=z+a deviation value of the target goods box and the goods box as the target marker in the front-rear direction.

If the target marker is the post 210 of the target shelving unit 200, for the coordinate value X of the target marker, X=x+a deviation value of the target goods box and the post 210 in the left-right direction. The deviation value is, for example, a distance between the target goods box and the post 210+the width of the target goods box/2. For the coordinate value Y of the target marker, if the height location of the target goods box is consistent with that of the post 210, Y=y. If the height of the target goods box is not consistent with that of the post 210, Y=y+a deviation value of the target goods box and the post 210 in the up-down direction. For the coordinate value Z of the target marker, if the location of the target goods box is consistent with that of the post 210 in the front-rear direction, Z=z. If the location of the target goods box is not consistent with that of the post 210 in the front-rear direction, Z=z+a deviation value of the target goods box and the post 210 in the front-rear direction.

If the target marker is an inner box, for the coordinate value X of the target marker, reference may be made to X of the inner box. For obtaining of the inner box X, reference may be made to the foregoing obtaining manner of the target marker as the goods box adjacent to the target goods box or the post 210 of the target shelving unit 200. For the coordinate values Y and Z of the target marker, reference may be made to the obtaining method of the foregoing target marker as the post 210 or the adjacent goods box.

It is to be noted that if the target marker is the goods box adjacent to the target goods box, the coordinate value x of the target marker in the X direction may be a coordinate value of a central location of a box, or may be a coordinate value of a certain location on an outer edge of the box. If the target marker is the post 210, the coordinate value x of the target marker in the X direction may be a coordinate value of a central location of the post 210, or may be a coordinate value of a certain location on the outer edge of the post 210.

In some embodiments, according to the goods box storage method in this embodiment of the present invention, there may be more than one target marker. Specifically, a plurality of target markers may be detected in a same task, and an accurate storage location of the target goods box is calculated based on locations of the plurality of target markers.

It may be understood that the target storage location is determined based on the locations of the plurality of target markers, which may improve accuracy of the storage location of the target goods box.

Further, each target marker may have different weights for correction of storage locations of goods boxes, and information about one or more target markers may be selected for calculation to obtain an accurate storage location. For example, the plurality of target markers are respectively denoted as p1, p2, p3, . . . , and pn, n being a quantity of the target markers. The weights of the plurality of target markers are correspondingly denoted as k1, k2, k3, . . . , and Kn respectively, and coordinates of the accurate storage location are P=(k1*p1+k2*p2+k3*p3+, . . . , kn*pn)/(k1+k2+k3+kn).

For example, a post 210 is arranged within a scanning monitoring range of the robot 100, and a goods box is stored at a location adjacent to a preset storage location of the target goods box. Location accuracy of the post 210 is greater than that of the goods box at the location adjacent to the preset storage location of the target goods box, so that the weight of the structural feature of the post 210 may be set to be greater than the weight of the structural feature of the goods box adjacent to the target goods box.

The plurality of target markers may be the structural feature of the target marker that is the goods box adjacent to the target goods box and the structural feature of the target shelving unit 200, or may be the structural feature of the target markers that are all the target shelving unit 200, and are at least two of the structural feature of the post 210, the structural feature of the transverse beam 230, and the structural feature of the shelf 220. The target markers may also be all the structural feature of the goods box adjacent to the target goods box, and there are at least two adjacent goods boxes. The target markers may also be the structural feature of the goods box on the shelving unit opposite to the target shelving unit and the structural feature of the goods box adjacent to the target goods box. The target markers may also be the structural feature of the goods box on the shelving unit opposite to the target shelving unit and the structural feature of the target shelving unit 200.

It may be understood that the robot 100 may transport the target goods box to the vicinity of the accurate storage location of the target goods box through the preset storage location of the target goods box. To store the goods box at an accurate storage location, the target marker is required. When the robot 100 moves to the preset location of the robot corresponding to the preset storage location of the target goods box, the target marker is scanned and detected, and the location of the target marker is determined. The target storage location of the target goods box is determined based on the location of the target marker.

S4: Control, based on the target storage location, the robot 100 to move from the preset location of the robot to store the target goods box on the target shelving unit 200.

It may be understood that the robot 100 adjusts a location of the robot 100 based on the accurate storage location to place the target goods box on the target shelving unit 200. After the robot 100 places the target goods box on the target shelving unit 200, the target goods box has an actual placement location. A specific deviation may exist between the actual placement location and the accurate storage location.

According to the goods box storage method in this embodiment of the present invention, the target storage location (an accurate storage location) of the target goods box is determined by using an existing shelving unit or another goods box placed on the shelving unit in a warehousing operation scene as the target marker. Since the target marker no longer adopts the identifier such as a QR code that needs to be attached in advance, according to the goods box storage method in this embodiment of the present invention, the identifier does not need to be attached in advance, which not only saves the labor time, but also reduces implementation costs.

In some embodiments, the step of detecting the target marker to which the target goods box belongs includes:
detecting a code pattern on the target shelving unit 200 to which the target goods box belongs; and
detecting the target marker to which the target goods box belongs in a case that the code pattern is not detected.

In other words, before the target marker is detected, a detection as to whether there is a code pattern on the target shelving unit 200 is performed first. If no code pattern is detected, the target marker is detected, and the target storage location of the target goods box is determined based on the location of the target marker. It is to be noted that the code pattern may be a QR code, a bar code, and the like. The code pattern may already exist on the target shelving unit 200, or may be attached to the target shelving unit 200 in advance.

In some embodiments, the goods box storage method of this embodiment of the present invention further includes: determining the target storage location of the target goods box on the target shelving unit 200 based on a location of the code pattern in a case that the code pattern is detected.

In other words, when the code pattern is arranged near the storage location of the target goods box on the target shelving unit 200, the code pattern is detected and decoded to obtain a location corresponding to the code pattern. The target storage location of the target goods box is determined through the location. Specifically, the code pattern may be arranged at a specific location on at least one of the post 210, the transverse beam 230, and the shelf 220 of the target shelving unit 200. The specific location on the post 210, the transverse beam 230, and the shelf 220 may be determined based on a specific situation.

For example, if it is detected that the code pattern is attached to the post 210 near a storage location of the target goods box, the target storage location of the target goods box is determined based on the code pattern, and the target goods box is stored at the target storage location. The robot 100 does not detect the code pattern when a storage operation is performed on a next target goods box, and the robot 100 may use a previous target goods box that has been placed as the target marker to determine the target storage location of the next target goods box.

It may be understood that, in some specific embodiments, some locations of the target shelving unit 200 may be provided with the code pattern, and some other locations of the target shelving unit 200 are not provided with the code pattern. For example, one or several layers of the target shelving unit 200 are all provided with the code pattern, but the remaining layers are not provided with the code pattern. Alternatively, one or several subspaces in a certain layer of the target shelving unit 200 are provided with the code pattern, but the remaining subspaces are not provided with the code pattern. Specifically, the code pattern is detected at a location where the code pattern is arranged, and the target storage location of the target goods box is determined based on the code pattern. At a location where no code pattern is arranged, at least one of the target shelving unit 200, the goods box adjacent to the target goods box, and the goods box on the shelving unit adjacent to the target goods box 200 is detected as the target marker, and the target storage location of the target goods box is determined based on the location of the target marker.

In some embodiments, the robot 100 includes a robot body 110 and a retrieval and storage mechanism 120 arranged on the robot body 110. The controlling, based on a preset storage location of a target goods box, a robot 100 to move to a preset location of the robot includes: controlling the robot body 110 to move to a first horizontal location, and controlling the retrieval and storage mechanism 120 to move to a first height location.

The retrieval and storage mechanism 120 on the robot body 110 moves synchronously with the robot body 110 in a horizontal direction. Therefore, after the robot body 110 travels to the first horizontal location on a storage region plane, the retrieval and storage mechanism 120 also synchronously moves to the first horizontal location in the horizontal direction, so that the retrieval and storage mechanism 120 can move to the first horizontal location aligned with a horizontal location indicated by the preset storage location information.

In this embodiment, the retrieval and storage mechanism 120 may respectively store different target goods boxes in storage spaces at different height locations. The retrieval and storage mechanism 12 may be lifted to the first height location relative to the storage region plane based on the height location indicated by the preset storage location information, so that the first height location corresponds to or is as identical as possible to the height location indicated by the preset storage location information. Therefore, the retrieval and storage mechanism 12 may reach the vicinity of a location where the storage operation is performed on the target goods box.

In some optional embodiments, the robot 100 may navigate to travel on the storage region plane by using at least one of navigation methods such as SLAM, QR code, and UWB.

In some embodiments, the retrieval and storage mechanism 120 is controlled to move to the first height location after the robot body 110 moves to the first horizontal location or when the robot body is moving toward the first horizontal location. In other words, when the robot body 110 is moving toward the first horizontal location, the robot 100 lifts the target goods box to the first height location through the retrieval and storage mechanism 120. In some other optional embodiments, after the robot body 110 reaches the first horizontal location, the robot 100 lifts the target goods box to the first height location through the retrieval and storage mechanism 120.

It may be understood that the robot body 110 lifts the target goods box through the retrieval and storage mechanism 120 when moving toward the first horizontal location, and then the robot body 110 may directly scan and detect the target marker after traveling to the first horizontal location, and determines the accurate storage location of the target goods box based on the structural feature of the target marker, thereby improving operating efficiency of the robot 100.

However, when a terrain restriction exists in the storage region, for example, when there is an obstacle on a traveling route of the robot 100, the retrieval and storage mechanism 120 of the robot 100 cannot lift the target goods box to the first height location. Alternatively, the first height location is excessively high and after the robot 100 lifts the target goods box to the first height location, an overall center of gravity of the robot 100 and the target goods box moves up, which may affect stability of the robot 100 during traveling. Therefore, after the robot body 110 moves to the first horizontal location, the retrieval and storage mechanism 120 is controlled to move to the first height location.

The retrieval and storage mechanism 120 is controlled to move to a second height location lower than the first height location before the robot body 110 moves to the first horizontal location, and the retrieval and storage mechanism 120 is controlled to move from the second height location to the first height location after the robot body 110 moves to the first horizontal location.

It may be understood that before the robot body 110 moves to the first horizontal location, the retrieval and storage mechanism 120 is controlled to move to the second height location, thereby preventing an excessively high location of the retrieval and storage mechanism 120 from affecting the traveling of the robot body 110. In addition, after the robot body 110 moves to the first horizontal location, the retrieval and storage mechanism 120 is controlled to move from the second height location to the first height location, thereby saving time for the retrieval and storage mechanism 120 to be lifted to the first horizontal location after the robot body 110 moves to the first horizontal location. Therefore, the operating efficiency of the robot 100 is improved.

In some embodiments, after the robot 100 moves to the preset location of the robot or when the robot is moving toward the preset location of the robot, the target storage location is determined based on the location of the target marker. In other words, the robot 100 scans and detects the location of the target marker when moving toward the preset location of the robot, and determines the target storage location based on the location of the target marker. Alternatively, the robot 100 scans and detects the location of the target marker after reaching the preset location of the robot, and determines the target storage location based on the location of the target marker.

It may be understood that, location coordinates of the target goods box in an X-axis direction, a Y-axis direction, and a Z-axis direction are all determined with reference to a warehousing region in which the robot body 110 operates. When the storage region plane is uneven or an error occurs in the robot 100, the storage location of the target goods box is different from the preset storage location of the target goods box. Then the robot 100 is needed to detect and collect the location of the target marker and calculate the target storage location of the target goods box, so that the robot 100 stores the target goods box based on the target storage location.

In some embodiments, during detection of the target marker, a box placement task is canceled if the target marker does not match a preset box storage feature or the target marker is not detected. It is to be noted that, for the target goods box stored at each corresponding location in each subspace 240, the target marker corresponding to the corresponding target goods box is stored in a server in advance. The target marker corresponding to the corresponding target goods box is the preset box storage feature. If the detected target marker is not within a preset box storage feature range, the target marker does not match the preset box storage feature.

The robot 100 scans and detects the target marker. When the target marker does not match the preset box storage feature, the robot 100 cancels a task of storing the target goods box. When the target marker is the same as the preset box storage feature, the robot 100 continues to perform the storage operation on the target goods box.

It may be understood that goods in different locations or different categories of goods may be stored in the storage region. Different categories of goods are stored in goods boxes with different structures, and goods boxes of the same category of goods are stored on the same shelving unit 200. When the robot 100 scans and detects that structural feature information of the target marker is inconsistent with that of the target marker corresponding to the target goods box that is being placed, the robot 100 cancels the task of storing the target goods box, to avoid a case in which goods boxes of different types are stored in a same storage region or the target goods box is stored at a storage location largely deviating from the target storage location.

When the robot 100 cannot detect the target marker, the robot 100 cancels the task of storing the target goods box. It may be understood that when the robot 100 cannot detect the target marker, the traveling route of the robot 100 may be wrong, and the robot does not reach the preset location of the robot, or the preset storage location is an incorrect location. The robot 100 stops the operation of storing the target goods box to avoid a storage location error of the target goods box.

In some embodiments, the goods box storage method in this embodiment of the present invention further includes:
detecting whether there is another goods box on the target storage location, and transmitting, to a server, information that another goods box exists on the target storage location if there is another goods box; and
controlling the robot 100 to cancel a box placement task, or reassigning a storage location to the target goods box, or controlling the robot 100 to retrieve the another goods box and place the another goods box at another location.

Specifically, after the robot 100 travels to the preset location of the robot, the robot 100 detects the target storage location of the target goods box on the target shelving unit 200. When there are no other goods boxes at the target storage location of the target goods box on the target shelving unit 200, the robot 100 continues to perform the storage operation on the target goods box.

When the another goods box is placed at the target storage location of the target goods box on the target shelving unit 200, the robot 100 may stop performing the storage operation on the target goods box and transmit information, to the server, that the another goods box exists at the location.

It may be understood that the robot 100 scans and detects the target storage location and then determines whether a goods box has been stored at the target storage location, so as to prevent the goods box already stored on the target shelving unit 200 from being squeezed out of the target shelving unit 200 by the target goods box, causing damage to the goods. For example, when the another goods box is stored at the target storage location of the target goods box, the robot 100 transmits information, to the server, that the another goods box exists at the target storage location, to ensure that during subsequent storage of the goods box, the server does not send a command to the robot 100 to store the goods box at the location where a goods box has been stored, which improves the operating efficiency of the robot 100.

When the another goods box is placed at the target storage location of the target goods box on the target shelving unit 200, the dispatching system may reassign the storage location to the target goods box, to control the robot to move based on the reassigned storage location and implement storage of the target goods box.

When the another goods box is placed at the target storage location of the target goods box on the target shelving unit 200, the robot 100 may also be controlled to retrieve the another goods box and place the another goods box at another location, so that the target goods box may be placed at the target storage location.

In some embodiments, the goods box storage method in this embodiment of the present invention further includes:
detecting an actual placement location of the target goods box after the target goods box is placed on the target shelving unit 200; and
comparing the actual placement location with the target storage location and determining a relative location error of the actual placement location relative to the target storage location, and controlling the robot 100 to retrieve the target goods box and relocate the target goods box if the relative location error does not satisfy a preset error condition.

Specifically, after the robot 100 places the target goods box on the target shelving unit 200, the robot 100 scans and detects the target goods box. When a location of the target goods box on the target shelving unit 200 is within an error range, the location of the target goods box does not need to be adjusted. When the location of the target goods box on the target shelving unit 200 exceeds the error range, the robot 100 corrects and adjusts the location of the target goods box again.

It may be understood that after the target goods box is placed on the target shelving unit 200, the robot 100 corrects the location of the target goods box again, thereby ensuring location accuracy of an actual storage location of the target goods box. On the one hand, the actual storage location of the target goods box may be kept substantially consistent with the target storage location of the target goods box. On the other hand, in the case of ensuring high location accuracy of the target goods box, the target goods box is used as the target marker when the robot 100 stores the another goods box, so that location storage accuracy of the another goods box may be improved.

In some embodiments, the goods box storage method in this embodiment of the present invention further includes: detecting space occupation information of the target shelving unit 200 and transmitting the space occupation information of the target shelving unit 200 to a server after the target goods box is placed on the target shelving unit 200.

It may be understood that the robot 100 detects the space occupation information of the target shelving unit 200, and transmits the space occupation information of the target shelving unit 200 to the server, so as to determine storage space information of the target shelving unit 200. In this way, the server can send an instruction for subsequent goods box storage to the robot 100 based on the storage space information of the target shelving unit 200, so as to store boxes with appropriate sizes into the storage space. The storage space information includes information about the location of the target goods box.

A robot according to an embodiment of the present invention is described below with reference to FIG. 2 and FIG. 3.

The robot 100 in this embodiment of the present invention includes a robot body 110, a retrieval and storage mechanism 120, a control unit 130, and a detection unit 140.

The retrieval and storage mechanism 120 is arranged on the robot body 110. Specifically, the retrieval and storage mechanism 120 is configured to lift and carry the target goods box. In other words, the robot 100 may move the target goods box to a target location through the retrieval and storage mechanism 120. After reaching the target location, the robot 100 may lift the retrieval and storage mechanism 120 to a target height, and then place the target goods box on the shelving unit 200.

The control unit 130 is configured to control, based on a preset storage location of the target goods box, the robot 100 to move to a preset location of the robot.

Specifically, the control unit 130 can control the robot body 110 to travel to the robot preset location based on the preset storage location of the target goods box. The control unit 130 may also control the retrieval and storage mechanism 120 to lift and lower based on the preset storage location of the target goods box, thereby adjusting a height of the target goods box.

The detection unit 140 is arranged on the retrieval and storage mechanism 120 and configured to detect a target marker to which the target goods box belongs. The target marker is a structural feature of at least one of a target shelving unit 200 to which the target goods box belongs, a goods box adjacent to the target goods box, and a goods box on a shelving unit opposite to the target shelving unit 200.

Specifically, the detection unit 140 includes an image capture apparatus 141 and an image processing apparatus 142. The robot 100 may collect a structural feature of the target marker through the image capture apparatus 141, for example, a post 210, a shelf 220, or a transverse beam 230 of the target shelving unit 200, then convert the collected structural feature of the target marker into an electrical signal through the image processing apparatus 142, and transmit the electrical signal with structural feature information of the target marker to the control unit 130, so that the control unit 130 determines a target storage location of the target goods box based on the structural feature of the target marker.

The detection unit 140 may be a lidar, a vision sensor, a TOF camera, an RGB-D camera, a binocular camera, a structured light camera, and the like.

It may be understood that the robot 100 may detect the target marker through the detection unit 140 and use location information of the target marker as a reference for the storage location of the target goods box, so as to store the target goods box.

The control unit 130 is further configured to determine the target storage location of the target goods box based on a location of the target marker, and control, based on the target storage location, the robot 100 to move to cause the retrieval and storage mechanism 120 to store the target goods box on the target shelving unit 200.

Specifically, the robot 100 may detect the location information of the target marker based on the detection unit 140. The control unit 130 determines the target storage location of the target goods box based on the location information of the target marker, and controls the robot 100 to place the target goods box based on the target storage location.

The robot 100 of this embodiment of the present invention may determine the target storage location (an accurate storage location) of the target goods box by detecting a location of the existing shelving unit 200 or another goods box already placed on the shelving unit 200 in a warehousing operation scene, and place the target goods box on the target shelving unit 200 based on the target storage location. Therefore, when the robot 100 of this embodiment of the present invention is used to store the target goods box, an identifier does not need to be attached to the target shelving unit 200, which not only saves labor time, but also reduces implementation costs.

In some embodiments, the detection unit 140 is configured to detect a code pattern to which the target goods box belongs, and detect the target marker to which the target goods box belongs in a case that the code pattern is not detected.

In other words, when the detection unit 140 of the robot 100 detects that there is a code pattern on the target shelving unit, the code pattern is preferentially detected. When the detection unit 140 of the robot 100 does not detect that there is a code pattern on the target shelving unit 200, at least one of the target shelving unit 200, the goods box adjacent to the target goods box, and the goods box on the shelving unit opposite to the target shelving unit 200 is used as the target marker.

In addition, the control unit is configured to determine the target storage location of the target goods box on the target shelving unit 200 based on a location of the code pattern in a case that the detection unit 140 detects the code pattern. It may be understood that the detection unit 140 of the robot 100 may first determine whether there is a code pattern on the target shelving unit 200. If there is a code pattern, the target storage location of the target goods box may be determined based on the code pattern, which saves time and improves storage efficiency of the goods box.

In some embodiments, the control unit 130 is configured to control, based on a preset storage location of the target goods box, the robot body 110 to move to a first horizontal location, and control the retrieval and storage mechanism 120 to move to a first height location.

Specifically, the robot 100 receives preset storage location information and carries the target goods box to navigate to travel to the first horizontal location based on the preset storage location information, and the robot 100 moves the target goods box to the first height location through the retrieval and storage mechanism 120, thereby transporting the target goods box to the preset storage location. It may be understood for the control unit 130 and the retrieval and storage mechanism 120 that the control unit 130 controls the robot body 110 to move to the first horizontal location, and controls the retrieval and storage mechanism 120 to move to the first height location, so that the target goods box approaches the preset storage location of the goods box, the detection unit 140 scans and detects the target marker near the preset storage location, and then the control unit 130 determines the target storage location of the target goods box.

In some optional embodiments, the robot 100 scans and detects the location of the target marker through the detection unit 140 when moving toward the preset location of the robot, and the control unit 130 determines the target storage location based on the location of the target marker. Alternatively, the robot 100 scans and detects the location of the target marker through the detection unit 140 after reaching the preset location of the robot, and the control unit 130 determines the target storage location based on the location of the target marker.

In some other embodiments, the robot 100 may detect, through the detection unit 140, whether the structural feature of the target marker satisfies a storage condition of the target goods box, and then decide whether to continue to perform a storage operation of the target goods box.

For example, if the detection unit 140 of the robot 100 detects that the target marker does not match the preset box storage feature or cannot detect the target marker, a box placement task is canceled.

It may be understood that goods in different locations or different categories of goods may be stored in the storage region. Different categories of goods are stored in goods boxes with different structures, and goods boxes of the same category of goods are stored on the same shelving unit 200. When the robot 100 scans and detects that structural feature information of the target marker is inconsistent with that of the target marker corresponding to the target goods box that is being placed, the robot 100 cancels the task of storing the target goods box, to avoid a case in which goods boxes of different types are stored in a same storage region or the target goods box is stored at a storage location largely deviating from the target storage location.

In still some embodiments, after the robot 100 places the target goods box on the target shelving unit 200, the detection unit 140 of the robot 100 detects space occupation information of the target shelving unit 200. After the detection unit 140 determines the space occupation information of the target shelving unit 200, the robot 100 transmits the space occupation information of the target shelving unit 200 to a server.

It may be understood that the robot 100 detects the space occupation information of the target shelving unit 200, and transmits the space occupation information of the target shelving unit 200 to the server, so as to determine storage space information of the target shelving unit 200. In this way, the server can send an instruction for subsequent goods box storage to the robot 100 based on the storage space information of the target shelving unit 200, so as to store boxes with appropriate sizes into the storage space. The storage space information includes information about the location of the target goods box.

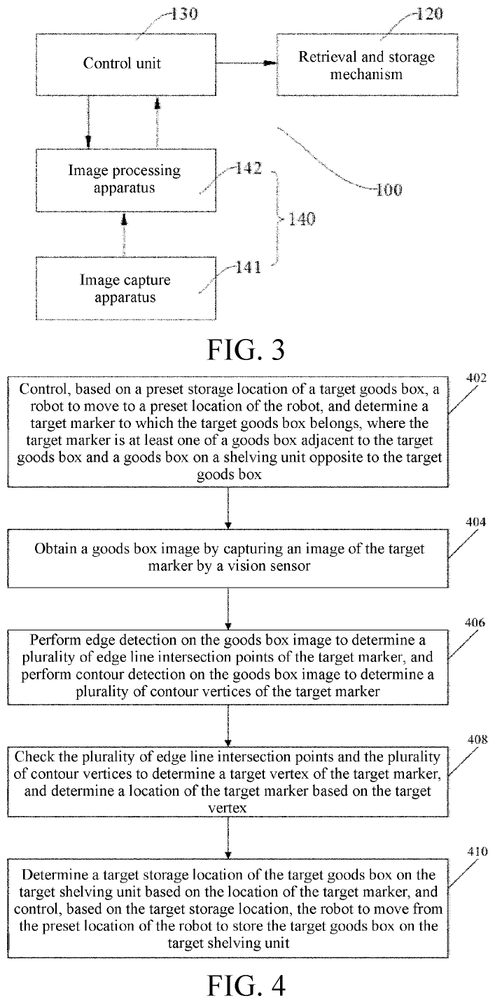

Referring to FIG. 4, FIG. 4 is another goods box storage method according to an embodiment of the present invention. The method specifically includes the following steps.

Step 402: Control, based on a preset storage location of a target goods box, a robot to move to a preset location of the robot, and determine a target marker to which the target goods box belongs, where the target marker is at least one of a goods box adjacent to the target goods box and a goods box on a shelving unit opposite to the target goods box.

For details of step 402, reference is made to the related content of step S1 in the foregoing embodiment, and details are not described herein again.

Step 404: Obtain a goods box image obtained by capturing an image of the target marker by a vision sensor.

In this embodiment of the present invention, the vision sensor may be an ordinary 2D vision sensor. Compared with a depth camera, the ordinary 2D vision sensor has low costs and better universality for a material of the goods box. Certainly, in this embodiment of the present invention, the vision sensor is not limited to the ordinary 2D vision sensor, which can capture an image of the target marker, and a vision sensor with a low requirement for the material of the goods box is applicable.

The vision sensor captures an image of a scene within a field of view, and the target marker needs to be included in the field of view, to ensure that a collected goods box image includes the target marker. Then the collected goods box image is transmitted to an execution subject of this embodiment of the present invention, so that the execution subject locates the target marker based on the goods box image.

In a practical application, the field of view of the vision sensor needs to include an entire front end contour of the target marker. Specifically, it may be ensured in the following three manners that the entire front end contour of the target marker is included within the field of view of the vision sensor. The first manner is obtaining the image captured by the vision sensor and identifying a quantity of vertices of the goods box in the image. It is first determined whether there are 4 vertices of the goods box. If the quantity of the vertices of the goods box is less than 4, a location relationship between an edge of the goods box and an edge of the image is identified. If it is determined based on the location relationship that the goods box is beyond the field of view, a control signal may be transmitted to a goods box storage and retrieval device, so that the goods box storage and retrieval device moves in a direction in which the goods box is beyond the field of view. The second manner is that the vision sensor directly adopts a vision sensor with a relatively large field of view such as a fish eye camera. The third manner is that after the vision sensor captures an image, the image may be displayed to a manager. The manager determines based on the displayed image whether the goods box is beyond the field of view. If the goods box is beyond the field of view, the goods box storage and retrieval device is manually controlled to move in the direction in which the goods box is beyond the field of view.

Step 406: Perform edge detection on the goods box image to determine a plurality of edge line intersection points of the target marker, and perform contour detection on the goods box image to determine a plurality of contour vertices of the target marker.

After the goods box image captured by the vision sensor is obtained, the target marker in the goods box image needs to be identified and located. However, to ensure a scope of application, the vision sensor may be the ordinary 2D vision sensor. The vision sensor does not collect abundant image information (such as depth data and color data). However, no matter what type of vision sensor, an edge and a contour of a target container may be collected. Therefore, to adapt to various types of vision sensors, locating of the target marker is performed through the edge detection and the contour detection in this embodiment of the present invention.

The locating of the target marker may be implemented through either the edge detection or the contour detection. However, this locating solution has poor accuracy. To improve the accuracy of locating the target marker, a combination of the edge detection and the contour detection is adopted to locate the goods box in this embodiment of the present invention.

The purpose of edge detection is to detect a point with an obvious gray level change in an image. However, in the goods box image of the warehousing field, a point with an obvious gray level change is often an edge of the goods box. Therefore, edge lines of the target marker in the goods box image may be obtained by detecting the edge of the goods box image. After a plurality of edge lines are detected, a plurality of edge line intersection points of the target marker may be obtained by finding intersection points of the plurality of edges. In some embodiments, the edge lines of the target marker in the goods box image may be directly identified through the edge detection, and then the plurality of edge line intersection points of the target marker may be directly obtained.

In an implementation of the embodiments of the present invention, the step of performing edge detection on the goods box image to determine a plurality of edge line intersection points of the target marker in step 406 may be specifically implemented in the following manner: performing edge detection on the goods box image to obtain a target edge detection image, where the target edge detection image includes a plurality of edge lines of the target marker in the goods box image; and identifying intersection points of the plurality of edge lines in the target edge detection image as the plurality of edge line intersection points of the target marker.

In this embodiment of the present invention, the edge detection may be directly performed in the goods box image, and the target edge detection image may be obtained. In the target edge detection image, the plurality of edge lines of the target marker in the goods box image is emphatically displayed (only the plurality of edge lines may be displayed, or the plurality of edge lines may be displayed in bold or with emphasis, or the like). In this way, the intersection points of the plurality of edge lines may be directly identified, thereby obtaining the plurality of edge line intersection points of the target marker. Through the method of the edge detection, the plurality of edge line intersection points of the target marker in the goods box image can be quickly determined, so that efficiency of locating the goods box is improved.

In an implementation of the embodiments of the present invention, the step of performing edge detection on the goods box image to obtain a target edge detection image may be specifically implemented in the following manner: performing edge detection on the goods box image to obtain an initial edge detection image; and fitting edge lines in the initial edge detection image to obtain the target edge detection image.

Under normal circumstances, due to impact of factors such as an angle and light rays of image collection, a slight error exists between the collected goods box image and an actual goods box image. In addition, a different edge detection method used may also lead to an error between the detected edge line and an actual edge line. To ensure that the detected target edge detection image is more accurate, and then ensure the accuracy of locating target marker, the edge lines in the initial edge detection image obtained through the edge detection need to be fitted.

Since the goods box is generally quadrilateral, in other words, the edge lines of the target marker are generally straight lines, then when the edge lines are fitted, a method of straight line fitting may be used. There are a number of methods of straight line fitting. For example, straight line fitting is performed by using a least square method, through Hough transform, and by using a gradient descent method and a unitary linear regression method. In the embodiment of the present invention, the method used for fitting is not specifically limited, as long as the purpose of edge line fitting can be achieved. Certainly, in some special scenes, the goods box may not be quadrilateral. For a non-quadrilateral goods box, a corresponding curve fitting method may be used during fitting of edge lines of a curve, or the curve is divided into a plurality of straight lines, and then the straight line fitting method is used for fitting.

In an implementation of the embodiments of the present invention, the step of performing edge detection on the goods box image to obtain an initial edge detection image may be specifically implemented in the following manner: performing gradient calculation on the goods box image to obtain the initial edge detection image.

As described above, the purpose of the edge detection is to detect the point with an obvious gray level change in the image. A gray level change may be measured as a rate of change of the gray level of the image by using a derivate (gradient). Therefore, the edge detection may be implemented by calculating the gradient of the goods box image. The gray level change in the image can be quickly and accurately calculated through the gradient calculation, which can improve accuracy and efficiency of the edge detection.

A gradient expression of an image function f (x, y) is expressed, as shown in Equation (1):

$$∇ f ( x , y ) = {[ {G}_{x} , {G}_{y} ]}^{T} = {[ \frac{\text{?}}{\text{?}} , \frac{\text{?}}{\text{?}} ]}^{T} \qquad ( 1 )$$

$$\text{?} \text{indicates text missing or illegible when filed}$$

An amplitude is shown in Equation (2):

$$mag ( ∇ f ) = g ( x , y ) = \sqrt{\frac{\text{?}}{\text{?}} + \frac{\text{?}}{\text{?}}} \qquad ( 2 )$$

$$\text{?} \text{indicates text missing or illegible when filed}$$

A direction angle is shown in Equation (3):

$$∅ ( x , y ) = arc tan \vert \frac{\text{?}}{\text{?}} / \frac{\text{?}}{\text{?}} \vert \qquad ( 3 )$$

$$\text{?} \text{indicates text missing or illegible when filed}$$

For an image, equivalently, gradients are calculated by using two-dimensional discrete functions, and derivatives are approximated by using a difference method, as shown in Equation (4).

$${G}_{x} ( x , y ) = H ( x + 1 , y ) - H ( x - 1 , y ) \qquad ( 4 )$$

$${G}_{y} ( x , y ) = H ( x , y + 1 ) - H ( x , y - 1 )$$

Therefore, a gradient value at a pixel point (x, y) is shown in Equation (5), and a gradient direction is shown in Equation (6):

$$G ( x , y ) = \sqrt{\text{?} {( x , y )}^{2} + {{G}_{y} ( x , y )}^{2}} \qquad ( 5 )$$

$$α ( x , y ) = ta \text{?} ( \frac{\text{?}}{\text{?}} ) \qquad ( 6 )$$

$$\text{?} \text{indicates text missing or illegible when filed}$$

It is learned from the above inference that a direction of the gradient is a direction in which a function changes fastest. Therefore, when an edge exists in the function, a relatively large gradient value exists. On the contrary, when there is a smooth part in the image, the gray level value changes little, and the corresponding gradient is also relatively small. During image processing, a mode of the gradient is referred to as a gradient for short, and an image composed of the image gradient becomes a gradient image.

In some classical image gradient calculations, the gray level change in a neighborhood of each pixel of the image is considered, and a gradient operator is set for a neighborhood of the pixel in an original image by using a law of change of a near-edge first or second derivative. A small region template is usually used to perform convolution for calculation, including a Sobel operator, a Robinson operator, a Laplace operator, and the like. In this embodiment of the present invention, the goods box image may be directly calculated by using the gradient operator. A horizontal gradient operator may be set to [1, 1, 1; 0, 0, 0; 1, 1, 1], and a vertical gradient operator may be set to [1, 0, 1; 1, 0, 1; 1, 0, 1]. The horizontal gradient operator and the vertical gradient operator are used to calculate the goods box image, so that Gₓ(x,y) and G_{y}(x,y) in the foregoing equation may be obtained. Further, the gradient value and the gradient direction may be calculated, and a gradient calculation result of the whole goods box image may be obtained. The edge lines of the target marker in the goods box image may be obtained based on the gradient calculation result of the goods box image.

The contour detection refers to a process of extracting a target contour in an image including a target and a background, ignoring impact of texture and noise interference inside the background and the target. In the embodiment of the present invention, the contour of the target marker in the goods box image is obtained by performing contour detection on the goods box image. After the contour of the target marker is detected, a plurality of contour vertices of the target marker may be obtained by identifying vertices of a contour shape.

In an implementation of the embodiments of the present invention, the step of performing contour detection on the goods box image to determine a plurality of contour vertices of the target marker in step 406 may be specifically implemented in the following manner: performing contour detection on the goods box image to obtain a target contour detection image, where the target contour detection image includes a contour of the target marker in the goods box image; and identifying vertices of the contour in the target contour detection image as a plurality of contour vertices of the target marker.

In the embodiment of the present invention, the contour detection may be directly performed in the goods box image, and the target contour detection image may be obtained. The contour of the target marker is highlighted in the target contour detection image. In this way, the vertices of the contour may be directly identified, and the plurality of contour vertices of the target marker are obtained. Through the method of the contour detection, the plurality of contour vertices of the target marker in the goods box image can be quickly determined, so that efficiency of locating the goods box is improved.

In an implementation of the embodiments of the present invention, the step of performing contour detection on the goods box image to obtain a target contour detection image may be specifically implemented in the following manner: performing contour detection on the goods box image to obtain an initial contour detection image; and fitting contours in the initial contour detection image to obtain the target contour detection image.

Under normal circumstances, due to impact of factors such as an angle and light rays of image collection, a slight error exists between the collected goods box image and an actual goods box image. In addition, a different contour detection method used may also lead to an error between the detected contour and an actual edge line. To ensure that the detected target contour detection image is more accurate, and then ensure the accuracy of locating the target marker, the contours in the initial contour detection image obtained through the contour detection need to be fitted.

Since the goods box is generally quadrilateral, the method of quadrilateral fitting may be used during fitting of the contours. The quadrilateral fitting is to fit sides of the collected contour, so that the contour is consistent with the actual quadrilateral to a greater extent. Certainly, in some special scenes, the goods box may not be quadrilateral. For a polygonal goods box, during the fitting, a corresponding polygonal fitting method may be used to fit the contours.

In a specific implementation, the polygon fitting method provided by an open-source cross-platform computer vision and machine learning software library (such as an OpenCV) may be used to fit the contours in the initial contour detection image. The OpenCV provides several methods such as a minimum envelope normal rectangle, a minimum envelope rectangle, a quadrilateral obtained by using a boundary point to perform fitting, and a minimum envelope quadrilateral to perform the quadrilateral fitting. These methods are all designed based on an algorithmic thought of an iterative endpoint fitting algorithm (also referred to as a Douglas-Peucker algorithm).

In an implementation of the embodiments of the present invention, the step of performing contour detection on the goods box image to obtain an initial contour detection image may be specifically implemented in the following manner: performing binarization on the goods box image to obtain the initial contour detection image.

In the embodiment of the present invention, the contour detection may be specifically performed through the binarization. To be specific, the binarization is performed on the goods box image to obtain the initial contour detection image. The binarization may be adaptive binarization. To be specific, the adaptive binarization is used for determining whether a pixel point in the goods box image is a darker region or a brighter region within a nearby interval, and a pixel value of the pixel point is compared with an average or a weighted average of pixel values of a surrounding region to obtain a binary image (i.e., the initial contour detection image). The binary image presents obvious visual effects of only black and white, and a coverage region of the target marker is obviously different from the surrounding region. Therefore, the coverage region of the target marker may be identified from the binary image. During binarization of the goods box image, since lighting conditions of parts of the goods box image may be uneven, the binarization may be performed on the goods box image by using a plurality of thresholds in blocks, and different binarization thresholds may be used for each image block. The efficiency and accuracy of locating the target marker are improved through the binarization.

In an implementation of the embodiments of the present invention, before step 406 is performed, the following step of performing filtering on the goods box image to obtain the goods box image with noise removed may also be performed.

Due to impact of the environment, the goods box image collected by the vision sensor often includes some noise. The noise of the image refers to unnecessary or redundant interference information existing in image data. Presence of the noise seriously affects image quality. Therefore, the noise needs to be removed before the image processing. In the embodiment of the present invention, the manner of performing the filtering on the goods box image is used to remove the noise. The method of the filtering mainly includes bilateral filtering, median filtering, Gaussian filtering, and the like. In the embodiment of the present invention, the bilateral filtering algorithm is preferentially used to perform filtering on the goods box image, which has a better filtering effect, so as to obtain the goods box image with noise removed.

Step 408: Check the plurality of edge line intersection points and the plurality of contour vertices to determine a target vertex of the target marker, and determine a location of the target marker based on the target vertex.

After the plurality of edge line intersection points and the plurality of contour vertices of the target marker are obtained through the edge detection and the contour detection, the edge line intersection points and the contour vertices at corresponding locations are to overlap. However, due to different detection means, an error generally exists between the obtained edge line intersection points and the contour vertices. Therefore, the plurality of edge line intersection points and the plurality of contour vertices need to be checked. The process of checking is to perform cross check on the edge line intersection points and the contour vertices at the same location and obtain a more accurate target vertex through cross check. The cross check may be to average the locations of the edge line intersection points and the contour vertices at the same location, or may be to select, as the target vertex based on the pixel information of the edge line intersection points and the contour vertices at the same location, a point of which the pixel information is consistent with an actual situation to a greater extent.

In an implementation of the embodiments of the present invention, the checking the plurality of edge line intersection points and the plurality of contour vertices to determine a target vertex of the target marker may be specifically implemented in the following manner: determining a first edge line intersection point and a first contour vertex at a same location; obtaining pixel information of each first pixel point within a preset range of the first edge line intersection points and pixel information of each second pixel point within a preset range of the first contour vertices; and determining the target vertex of the target marker based on the pixel information of each first pixel point and the pixel information of each second pixel point.

During checking of the plurality of edge line intersection points and the plurality of contour vertices, the first edge line intersection point and the first contour vertex at the same location are first determined. Then the pixel information of each first pixel point within a preset range of the first edge line intersection points is obtained (the pixel information of 8 pixel points nearby the first edge line intersection point may be usually obtained) with the first edge line intersection point as a center, and the pixel information of each second pixel point within a preset range of the first contour vertices is obtained with the first contour vertex as the center. The pixel information mentioned herein refers to attribute data of the pixel point, which may be a pixel value, a gray level value, and the like. The pixel information of each first pixel point and the pixel information of each second pixel point represent pixel distribution characteristics around the first edge line intersection point and the first contour vertex. However, in an actual scene, the pixel distribution of the target vertex of the goods box has a specific law. Based on the law, the target vertex of the target marker is determined based on the pixel information of each first pixel point and the pixel information of each second pixel point.

A plurality of manners of determining the target vertex are provided, which may be determining which of the pixel information of each first pixel point and the pixel information of each second pixel point is consistent with the foregoing law. It can be further determined whether the first edge line intersection point is determined as the target vertex or the first contour vertex is determined as the target vertex. The manner of determining the target vertex may also be performing weighted processing on the pixel information of each first pixel point and the pixel information of each second pixel point, and then determining whether a weighted result is consistent with the foregoing law. If not, the location of the first edge line intersection point and the first contour vertex is adjusted until the weighted result is consistent with the foregoing law, and then the target vertex is determined.

In an implementation of the embodiments of the present invention, the step of determining the first edge line intersection point and the first contour vertex at the same location may be specifically implemented in the following manner: identifying a preset identifier in the goods box image, where the preset identifier is arranged at each vertex of the target marker in advance; calculating a first distance between each of the plurality of edge line intersection points and the preset identifier, and a second distance between each of the plurality of contour vertices and the preset identifier; and determining the first edge line intersection point and the first contour vertex at the same location based on the first distance and the second distance.

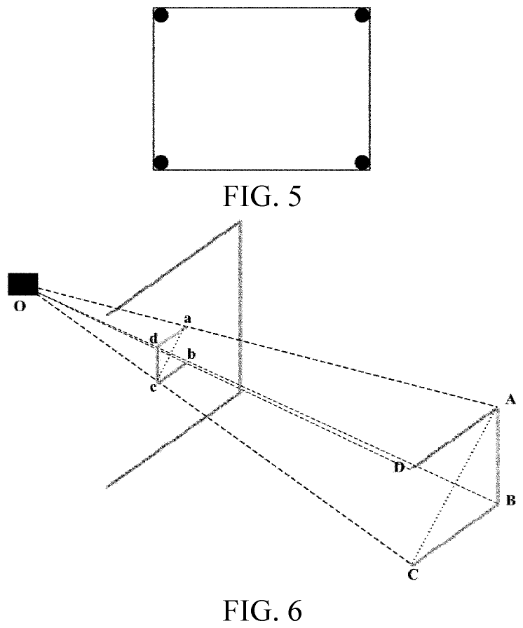

To locate the first edge line intersection point and the first contour vertex located at the same location more accurately, in this embodiment of the present invention, a preset identifier may be arranged at each vertex of the target marker in advance. The preset identifier is a geometric identifier. As shown in FIG. 5, FIG. 5 is a schematic diagram of a front end contour of a target marker according to an embodiment of the present invention. A circular identifier is arranged at each of 4 vertices of the target marker. Certainly, the circular identifier is only an example. The preset identifier may also be rectangular, triangular, and the like, which is not specifically limited herein. The preset identifier is fixed at each vertex of the target marker, and is fixed with respect to the location of the target marker, and the detection is simple.

During searching of the vertex, the preset identifier in a goods box image may be identified first. Then a first distance between the plurality of edge line intersection points and the preset identifier and a second distance between the plurality of contour vertices and the preset identifier are calculated. Under normal circumstances, a difference between the first distance between the edge line intersection points and a preset identifier and the second distance between the contour vertex and the preset identifier is very small (less than a specific threshold), and the first distance and the second distance are also small. It indicates that the edge line intersection point and the contour vertex are the edge line intersection point and the contour vertex corresponding to the vertex where the preset identifier is located. To be specific, the first edge line intersection point and the first contour vertex located at the same location can be determined based on the first distance and the second distance, and a location of a vertex where the preset identifier is actually located can also be determined.

In an implementation of the embodiments of the present invention, the step of determining the target vertex of the target marker based on the pixel information of each first pixel point and the pixel information of each second pixel point may be specifically implemented in the following manner: determining a first pixel gray level distribution within the preset range of the first edge line intersection points based on the pixel information of each first pixel point, and determining a second pixel gray level distribution within the preset range of the first contour vertices based on the pixel information of each second pixel point; determining, from the first pixel gray level distribution and the second pixel gray level distribution, a target pixel gray level distribution that is consistent with a preset distribution rule; and determining the target vertex of the target marker from the first edge line intersection point and the first contour vertex based on the target pixel gray level distribution.

The first pixel gray level distribution within the preset range of the first edge line intersection points may be calculated based on the pixel information of each first pixel point, and the second pixel gray level within the preset range of the first contour vertices may be calculated based on the pixel information of each second pixel point. Specifically, the pixel information may be a gray level value. Therefore, the first pixel gray level distribution and the second pixel gray level distribution may be obtained by extracting the gray level values of each first pixel point and each second pixel point. If an ideal vertex is obtained, the gray level distribution around the vertex is to be that three-quarters of gray level values of a region are within a threshold range, and a quarter of the gray level values of the region is within another threshold range. Then after the first pixel gray level distribution and the second pixel gray level distribution are obtained, a target pixel gray level distribution that is consistent with the preset distribution rule may be determined therefrom. In other words, it is determined which of the first pixel gray level distribution and the second pixel gray level distribution can satisfy the foregoing distribution rule, and the pixel gray level distribution that satisfies the rule is used as the target pixel gray level distribution. Then the target vertex of the target marker is determined from the first edge line intersection point and the first contour vertex based on the target pixel gray level distribution. In other words, if the first pixel gray level distribution corresponding to the first edge line intersection point satisfies the foregoing distribution rule, the first edge line intersection point is used as the target vertex. If the second pixel gray level distribution corresponding to the first contour vertex satisfies the foregoing distribution rule, the first contour vertex is used as the target vertex.

Further, after the target vertex of the target marker is obtained, the location of the target marker may be determined based on the target vertex. A manner of determining the location of the target marker may be the perspective-n-point (PnP) locating algorithm, or another locating algorithm based on a vision sensor. The location refers to actual locating information of the target marker relative to the vision sensor. The location may include information such as a size and a pose of the target marker.

In an implementation of the embodiments of the present invention, a contour shape of the target marker is a quadrilateral. Correspondingly, the determining the location of the target marker based on the target vertex may be specifically implemented in the following manner: obtaining vertex information of any three target vertices from four target vertices of the target marker; and calculating, based on the vertex information of the three target vertices, pose information of the target marker relative to the vision sensor by using a preset perspective projection algorithm.

Since the contour shape of the target marker is a quadrilateral, the P3P locating algorithm may be used for locating the quadrilateral. In other words, during the locating, the vertex information of the three target vertices may be obtained from the four target vertices of the target marker. The vertex information may be information such as vertex coordinates and vertex pixels. Certainly, a priori information of a width and a height of the target marker may also be obtained, and then the pose information of the target marker relative to the vision sensor may be calculated based on the vertex information of these three target vertices by using a preset perspective projection algorithm (i.e., the P3P algorithm).

As shown in FIG. 6, FIG. 6 is a projection view of a target marker according to an embodiment of the present invention. ABCD are 4 vertices of a front end contour of the target marker, O is a viewpoint of a vision sensor, and abcd are 4 vertices obtained after the target marker is projected onto a projection plane.

The three vertices A, B, and C are used for calculation. It is provided that lengths of BC, AC, and AB (i.e., a priori information of a width and a height of the target marker) are known, ∠AOC=∠aOc, ∠BOC=∠bOc, ∠AOB=∠aOb, a=(u₀, v₀, 1), b=(u₁, v₁, 1), and c=(u₂, v₂, 1).

Three angles may be calculated according to Equation (7), as shown in Equation (8):

$$\vec{ob} \cdot \vec{oc} = \vert \vec{ob} \vert \vert \vec{oc} \vert cos α cos α = \frac{\text{?}}{\text{?}} = \vec{{e}_{b}} \times \vec{{e}_{c}} \qquad ( 7 )$$

$$\vec{oa} \cdot \vec{oc} = \vert \vec{oa} \vert \vert \vec{oc} \vert cos β cos β = \frac{\text{?}}{\text{?}} = \vec{{e}_{a}} \times \vec{{e}_{c}}$$

$$\vec{oa} \cdot \vec{ob} = \vert \vec{oa} \vert \vert \vec{ob} \vert cos γ cos γ = \frac{\text{?}}{\text{?}} = \vec{{e}_{a}} \times \vec{{e}_{b}}$$

$$\vec{{e}_{a}} = ( \begin{matrix}\frac{\text{?}}{\text{?}} , & \frac{\text{?}}{\text{?}} , & \frac{\text{?}}{\text{?}} )\end{matrix} \qquad ( 8 )$$

$$\vec{{e}_{b}} = ( \begin{matrix}\frac{\text{?}}{\text{?}} , & \frac{\text{?}}{\text{?}} , & \frac{\text{?}}{\text{?}} )\end{matrix}$$

$$\vec{{e}_{c}} = ( \begin{matrix}\frac{\text{?}}{\text{?}} , & \frac{\text{?}}{\text{?}} , & \frac{\text{?}}{\text{?}} )\end{matrix}$$

$$\text{?} \text{indicates text missing or illegible when filed}$$

According to the cosine law, an equation shown in Equation (9) holds:

$${OB}^{2} + {OC}^{2} - 2 OB \cdot OC \cdot cos α = {BC}^{2} \qquad ( 9 )$$

$${OA}^{2} + {OC}^{2} - 2 OA \cdot OC \cdot cos β = {AC}^{2}$$

$${OA}^{2} + {OB}^{2} - 2 OA \cdot OB \cdot cos γ = {AB}^{2}$$

To simplify the calculation, variable substitution is performed as shown in Equation (10) (all variables are transformed such that they are related to OC, to perform elimination):

$$OA = xOC , OB = yOC \qquad ( 10 )$$

$$p = 2 cos α , q = 2 cos β , r = 2 cos γ$$

$${AB}^{2} = {vOC}^{2} , {BC}^{2} = {aAB}^{2} = {avOC}^{2} , {AC}^{2} = {bAB}^{2} = {bvOC}^{2} v = \frac{\text{?}}{\text{?}} , a = \frac{\text{?}}{\text{?}} , b = \frac{\text{?}}{\text{?}}$$

$$\text{?} \text{indicates text missing or illegible when filed}$$

After the variable substitution, Equation (11) may be obtained through transformation:

$${y}^{2} + 1 - yp - av = 0 \qquad ( 11 )$$

$${x}^{2} + 1 - xq - bv = 0$$

$${x}^{2} + {y}^{2} - xyr - v = 0 v = {x}^{2} + {y}^{2} - xyr$$

V is substituted into the first two equations for further elimination, to obtain a system of binary quadratic equations, as shown in Equation (12):

$${y}^{2} + 1 - yp - a ( {x}^{2} + {y}^{2} - xyr ) = 0 ( 1 - a ) {y}^{2} - {ax}^{2} - yp + axyr + 1 = 0 \qquad ( 12 )$$

$${y}^{2} + 1 - yq - b ( {x}^{2} + {y}^{2} - xyr ) = 0 ( 1 - b ) {x}^{2} - {by}^{2} - yq + bxyr + 1 = 0$$

p, q, r, a, and b are known quantities, and x and y are unknown quantities. The equation is solved according to the Wu elimination method, and x and y are obtained, thereby obtaining coordinates of the three points ABC in the coordinate system of the vision sensor. A three-dimensional world coordinate system is established based on a surface of the target marker, world coordinates of the three points ABC are also known, and the pose information of the target marker relative to the vision sensor may be solved according to an ICP algorithm. The pose information may be represented by a matrix R and a matrix T of the pose.

Step 410: Determine a target storage location of the target goods box on the target shelving unit based on the location of the target marker, and control, based on the target storage location, the robot to move from the preset location of the robot to store the target goods box on the target shelving unit.

For details of step 410, reference is made to the related contents of step S3 and S4 in the foregoing embodiment, and details are not described herein again.

In an implementation of the embodiments of the present invention, after the step of calculating, based on the vertex information of the three target vertices, the pose information of the target marker relative to the vision sensor by using the preset perspective projection algorithm, the following steps may also be performed: projecting a remaining target vertex among the four target vertices in addition to any three target vertices onto a goods box image based on the pose information, to obtain projection coordinates of the remaining target vertex; obtaining vertex coordinates of the remaining target vertex in the goods box image; calculating an error value based on the projection coordinates and the vertex coordinates; updating the pose information based on the error value, and repeating the step of projecting the remaining target vertex among the four target vertices in addition to the three target vertices onto the goods box image based on the pose information, to obtain the projection coordinates of the remaining target vertex; and determining that an updated pose information is target pose information of the target marker relative to the vision sensor in a case that the error value is less than or equal to a preset threshold.

The pose information of the target marker relative to the vision sensor is calculated based on the vertex information of the three target vertices by using the preset perspective projection algorithm. However, during the calculation, an error is inevitably to be introduced, which leads to the obtained pose information that is not very accurate. Therefore, the remaining target vertex among the four target vertices in addition to the three target vertices needs to be used to check the pose information. A specific checking process of the pose information includes: projecting the remaining target vertex onto the goods box image based on the pose information to obtain the projection coordinates of the remaining target vertex, calculating an error between the projection coordinates and vertex coordinates actually detected by the remaining target vertex to obtain the error value, then updating the pose information based on the error value through the principle of backpropagation of an error gradient, and so on until the pose information with the error value less than or equal to the preset threshold is obtained. The pose information is checked by using the remaining target vertex among the four target vertices in addition to the three target vertices, so that the finally determined pose information is more accurate, thereby improving accuracy of locating the target marker.

Through application of this embodiment of the present invention, the goods box image obtained by capturing an image of the target marker by the vision sensor is obtained. Edge detection is performed on the goods box image to determine a plurality of edge line intersection points of the target marker, and contour detection is performed on the goods box image to determine a plurality of contour vertices of the target marker. The plurality of edge line intersection points and the plurality of contour vertices are checked to determine a target vertex of the target marker. A location of the target marker is determined based on the target vertex. The edge detection and the contour detection are performed on the goods box image captured by the vision sensor, so as to respectively obtain the plurality of edge line intersection points and the plurality of contour vertices of the target marker. It is determined by checking the plurality of edge line intersection points and the plurality of contour vertices that the target vertex of the target marker is more accurate, and then it is determined based on the target vertex that the location of the target marker is more accurate, which improves accuracy of locating the target marker.

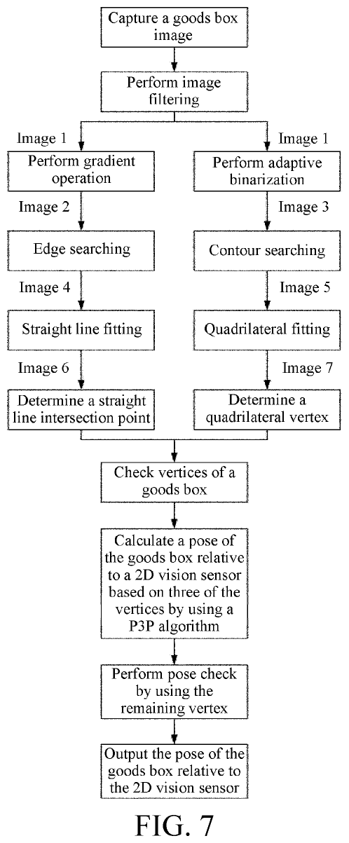

The target marker in the foregoing embodiment may be specifically a goods box. For ease of understanding, a goods box locating method provided in an embodiment of the present invention is introduced below based on an application scene of retrieving and placing the goods box. In this embodiment of the present invention, a goods box storage and retrieval device includes a retrieval and storage apparatus for retrieving and placing the goods box. A 2D vision sensor is mounted to a bottom of the retrieval and storage apparatus. A goods box storage device further includes a processor. The goods box locating method shown in FIG. 7 is performed by the processor. FIG. 7 is a flowchart of another goods box locating method according to an embodiment of the present invention, which specifically includes the following steps.
Step I: Capture a goods box image. A 2D vision sensor obtains the goods box image by capturing an image of a target goods box. A field of view of the 2D vision sensor needs to include an entire front end contour of a goods box.
Step II: Perform image filtering. Bilateral filtering is performed on the goods box image captured by the 2D vision sensor in step I, to obtain an image 1 with noise removed.
Step III: Perform gradient operation and adaptive binarization. A horizontal gradient and a vertical gradient of the image 1 obtained in step II are calculated to obtain an image 2. The adaptive binarization is performed simultaneously and in parallel on the image 1 to obtain an image 3.
Step IV: Perform edge searching and contour searching. The edge searching is performed on the image 2 obtained in step III to obtain an image 4, and the outline searching is performed on the image 3 to obtain an image 5. The edge searching is a pixel location in the image 2 at which gradient intensity is greater than a specific threshold after gradient calculation. This is because a significant gray level change and therefore a strong gradient response occur at edges. The contour searching is to identify a boundary contour of the image 3.
Step V: Perform straight line fitting and quadrilateral fitting. Straight line fitting is performed on edge lines in the image 4 obtained in step IV, to obtain an image 6, and the quadrilateral fitting is performed on a quadrilateral contour shape in the image 5 to obtain an image 7. For details of the manner of straight line fitting and quadrilateral fitting, reference is made to the embodiment shown in FIG. 4, and the details are not described herein again.
Step VI: Determine a straight line intersection point and a quadrilateral vertex. For the image 6 obtained in step V, an intersection point of straight lines in the image 6 is found to obtain a plurality of straight line intersection points, and the image 7 is searched for quadrilateral contour vertices to obtain a plurality of quadrilateral vertices.
Step VII: Check vertices of a goods box.

For the plurality of straight line intersection points and the plurality of quadrilateral vertices obtained in step VI, a first straight line intersection point and a first quadrilateral vertex located at the same location are first determined. Then a gray level value of each first pixel point within a preset range of the first straight line intersection points is obtained with the first straight line intersection point as a center, and a gray level value of each second pixel point within a preset range of the first contour vertices is obtained with the first contour vertex as the center. A first pixel gray level distribution and a second pixel gray level distribution are obtained by extracting the gray level values of each first pixel point and each second pixel point. If an ideal vertex is obtained, the gray level distribution around the vertex is to be that three-quarters of gray level values of a region are within a threshold range, and a quarter of the gray level values of the region is within another threshold range. Then after the first pixel gray level distribution and the second pixel gray level distribution are obtained, a target pixel gray level distribution that is consistent with the preset distribution rule may be determined therefrom. In other words, it is determined which of the first pixel gray level distribution and the second pixel gray level distribution can satisfy the foregoing distribution rule, and the pixel gray level distribution that satisfies the rule is used as the target pixel gray level distribution. Then a target vertex of the goods box is determined from the first straight line intersection point and the first quadrilateral vertex based on the target pixel gray level distribution. In other words, if the first pixel gray level distribution corresponding to the first straight line intersection point satisfies the foregoing distribution rule, the first straight line intersection point is used as the target vertex. If the second pixel gray level distribution corresponding to the first quadrilateral vertex satisfies the foregoing distribution rule, the first quadrilateral vertex is used as the target vertex.
Step VIII: Calculate a pose of the goods box relative to the 2D vision sensor based on three of the vertices by using a P3P algorithm. For the four vertices of the goods box obtained in step VII, the pose of the goods box relative to the 2D vision sensor is calculated based on the three vertices and a priori information of a width and a height of the goods box by using the P3P algorithm. For a specific algorithm implementation process, reference is made to the embodiments shown in FIG. 4 and FIG. 6. Details are not described herein again.
Step IX: Perform pose check by using a remaining vertex.

For the pose of the goods box obtained in step VIII, the pose of the goods box is checked by using the remaining vertex. To be specific, the remaining vertex is projected onto the image based on the pose information to obtain the projection coordinates of the remaining vertex, an error between the projection coordinates and actually detected vertex coordinates of the remaining vertex is calculated to obtain an error value, then the pose information is updated based on the error value through the principle of backpropagation of an error gradient, and so on until the pose information with the error value less than or equal to a preset threshold is obtained. The pose information is checked by using the remaining vertex among the four target vertices, so that the finally determined pose information is more accurate, thereby improving accuracy of locating the target marker.
Step X: Output the pose of the goods box relative to the 2D vision sensor.

In the present invention, an ordinary 2D vision sensor is used without relying on a depth camera. Therefore, costs are lower, and material universality of the goods box is stronger. In addition, the goods box may be directly located without relying on a goods location identification code, avoiding inaccuracy of an actual location of the goods box as a result of a change of a relative location between the goods box and the goods location identification code. In this way, information such as an actual angle and a depth of the goods box can be obtained.

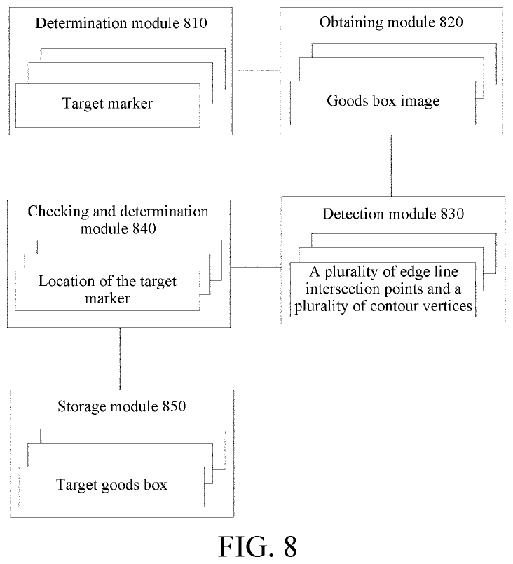

Corresponding to the foregoing method embodiment, the present invention further provides an embodiment of a goods box storage apparatus. FIG. 8 is a schematic structural diagram of a goods box storage apparatus according to an embodiment of the present invention. As shown in FIG. 8, the apparatus includes:
a determination module 810, configured to control, based on a preset storage location of a target goods box, a robot to move to a preset location of the robot, and determine a target marker to which the target goods box belongs, where the target marker is at least one of a goods box adjacent to the target goods box and a goods box on a shelving unit opposite to the target goods box;
an obtaining module 820, configured to obtain a goods box image obtained by capturing an image of the target marker by a vision sensor;
a detection module 830, configured to perform edge detection on the goods box image to determine a plurality of edge line intersection points of the target marker, and perform contour detection on the goods box image to determine a plurality of contour vertices of the target marker;
a checking and determination module 840, configured to check the plurality of edge line intersection points and the plurality of contour vertices to determine a target vertex of the target marker, and determine a location of the target marker based on the target vertex; and
a storage module 850, configured to determine a target storage location of the target goods box on the target shelving unit based on the location of the target marker, and control, based on the target storage location, the robot to move from the preset location of the robot to store the target goods box on the target shelving unit.

Through application of this embodiment of the present invention, the goods box image obtained by capturing an image of the target marker by the vision sensor is obtained. Edge detection is performed on the goods box image to determine a plurality of edge line intersection points of the target marker, and contour detection is performed on the goods box image to determine a plurality of contour vertices of the target marker. The plurality of edge line intersection points and the plurality of contour vertices are checked to determine a target vertex of the target marker. A location of the target marker is determined based on the target vertex. The edge detection and the contour detection are performed on the goods box image captured by the vision sensor, so as to respectively obtain the plurality of edge line intersection points and the plurality of contour vertices of the target marker. It is determined by checking the plurality of edge line intersection points and the plurality of contour vertices that the target vertex of the target marker is more accurate, and then it is determined based on the target vertex that the location of the target marker is more accurate, which improves accuracy of locating the target marker.

In one embodiment, the detection module 830 may be further configured to perform edge detection on the goods box image to obtain a target edge detection image, where the target edge detection image includes a plurality of edge lines of the target marker in the goods box image; and identify intersection points of the plurality of edge lines in the target edge detection image as the plurality of edge line intersection points of the target marker.

In one embodiment, the detection module 830 may be further configured to perform edge detection on the goods box image to obtain an initial edge detection image; and fit edge lines in the initial edge detection image to obtain the target edge detection image.

In one embodiment, the detection module 830 may be further configured to perform gradient calculation on the goods box image to obtain the initial edge detection image.

In one embodiment, the detection module 830 may be further configured to perform contour detection on the goods box image to obtain a target contour detection image, where the target contour detection image includes a contour of the target marker in the goods box image; and identify vertices of the contour in the target contour detection image as a plurality of contour vertices of the target marker.

In one embodiment, the detection module 830 may be further configured to perform contour detection on the goods box image to obtain an initial contour detection image; and fit contours in the initial contour detection image to obtain the target contour detection image.

In one embodiment, the detection module 830 may be further configured to perform binarization on the goods box image to obtain the initial contour detection image.

In one embodiment, the checking and determination module 840 may be further configured to: determine a first edge line intersection point and a first contour vertex at a same location; obtain pixel information of each first pixel point within a preset range of the first edge line intersection points and pixel information of each second pixel point within a preset range of the first contour vertices; and determine the target vertex of the target marker based on the pixel information of each first pixel point and the pixel information of each second pixel point.

In one embodiment, the checking and determination module 840 may be further configured to: identify a preset identifier in the goods box image, where the preset identifier is arranged at each vertex of the target marker in advance; calculate a first distance between each of the plurality of edge line intersection points and the preset identifier and a second distance between each of the plurality of contour vertices and the preset identifier; and determine the first edge line intersection point and the first contour vertex at the same location based on the first distance and the second distance.

In one embodiment, the checking and determination module 840 may be further configured to: determine a first pixel gray level distribution within the preset range of the first edge line intersection points based on the pixel information of each first pixel point, and determine a second pixel gray level distribution within the preset range of the first contour vertices based on the pixel information of each second pixel point; determine, from the first pixel gray level distribution and the second pixel gray level distribution, a target pixel gray level distribution that is consistent with a preset distribution rule; and determine the target vertex of the target marker from the first edge line intersection point and the first contour vertex based on the target pixel gray level distribution.

In one embodiment, a contour shape of the target marker is a quadrilateral.

Correspondingly, the checking and determination module 840 may be further configured to: obtain vertex information of any three target vertices from four target vertices of the target marker; and calculate, based on the vertex information of the three target vertices, pose information of the target marker relative to the vision sensor by using a preset perspective projection algorithm.

In one embodiment, the checking and determination module 840 may be further configured to: project a remaining target vertex among the four target vertices in addition to the three target vertices onto a goods box image based on the pose information, to obtain projection coordinates of the remaining target vertex; obtain vertex coordinates of the remaining target vertex in the goods box image; calculate an error value based on the projection coordinates and the vertex coordinates; update the pose information based on the error value, and repeat the step of projecting the remaining target vertex among the four target vertices in addition to the three target vertices onto the goods box image based on the pose information, to obtain the projection coordinates of the remaining target vertex; and determine that an updated pose information is target pose information of the target marker relative to the vision sensor in a case that the error value is less than or equal to a preset threshold.

In one embodiment, the apparatus further includes:
a filter module, configured to perform filtering on the goods box image to obtain the goods box image with noise removed.

In one embodiment, the target marker is a goods box.

The above is a schematic solution of a goods box storage apparatus of this embodiment. It is to be noted that the technical solution of the goods box storage apparatus and the technical solution of the foregoing goods box storage method belong to the same concept. For details not described in detail in the technical solution of the goods box storage apparatus, reference may be made to the description of the technical solution of the foregoing goods storage method.

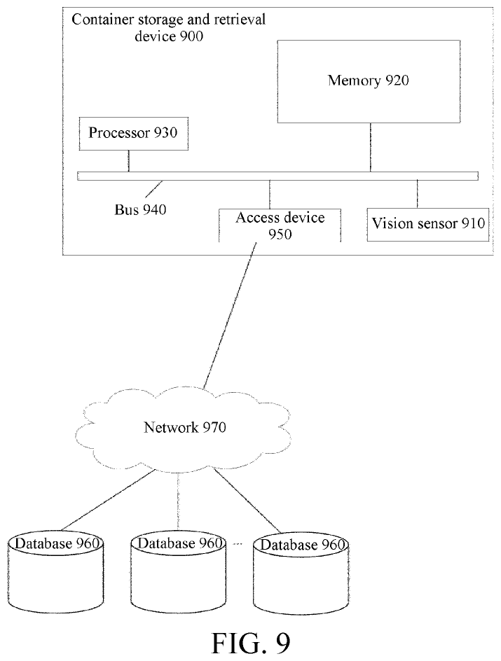

FIG. 9 is a structural block diagram of a goods box storage and retrieval device according to an embodiment of the present invention. Components of the goods box storage and retrieval device 900 include, but are not limited to, a vision sensor 910, a memory 920, and a processor 930. The processor 930 is connected to the vision sensor 910 and the memory 920 through a bus 940, and a database 960 is configured to store data.

The goods box storage and retrieval device 900 further includes an access device 950. The access device 950 enables the goods box storage and retrieval device 900 to perform communication through one or more networks 970. Examples of these networks include a public switched telephone network (PSTN), a local area network (LAN), a wide area network (WAN), a personal area network (PAN), or a combination of communication networks such as the Internet. The access device 950 may include one or more of any type of wired or wireless network interface (for example, a network interface controller (NIC)), such as an IEEE802.11 wireless LAN (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of the present invention, the foregoing components of the goods box storage and retrieval device 900 and other components not shown in FIG. 9 may also be connected to each other, for example, through a bus. It is to be understood that the structural block diagram of the goods box storage and retrieval device shown in FIG. 9 is merely for the purpose of illustration, and is not intended to limit the scope of the present invention. A person skilled in the art may add or replace the other components as needed.

The vision sensor 910 is configured to capture an image and transmit the image to the processor 930. The processor 930 is configured to execute the following computer-executable instruction. The computer-executable instruction, when executed by the processor, implements steps of:
obtaining a goods box image obtained by capturing an image of the target marker by the vision sensor 910;
performing edge detection on the goods box image to determine a plurality of edge line intersection points of the target marker, and performing contour detection on the goods box image to determine a plurality of contour vertices of the target marker;
checking the plurality of edge line intersection points and the plurality of contour vertices to determine a target vertex of the target marker; and
determining the location of the target marker based on the target vertex.

After the location is obtained, the goods box storage and retrieval device may be controlled to retrieve the target marker based on the location.

The above is a schematic solution of a goods box storage and retrieval device of this embodiment. It is to be noted that the technical solution of the goods box storage and retrieval device and the technical solution of the foregoing goods box storage method belong to the same concept. For details not described in detail in the technical solution of the goods box storage and retrieval device, reference may be made to the description of the technical solution of the foregoing goods storage method.

An embodiment of the present invention further provides a computer-readable storage medium, having a computer-executable instruction stored therein. The computer-executable instruction, when executed by a processor, implements steps of the foregoing goods box storage method.

The above is a schematic solution of the computer-readable storage medium of this embodiment. It is to be noted that, the technical solution of the storage medium and the technical solution of the foregoing goods box storage method belong to the same concept. For details not described in detail in the technical solution of the storage medium, reference may be made to the description of the technical solution of the foregoing goods box storage method.

Particular embodiments of the present invention are described above. Other embodiments fall within the scope of the appended claims. In some cases, the actions or steps described in the claims may be performed in a sequence different from that in the embodiments, and desired results may still be achieved. In addition, the processes depicted in the accompanying drawings are not necessarily performed in a specific sequence or sequential order to achieve the desired results. In some implementations, multitasking and parallel processing are also possible or may be advantageous.

The computer instruction includes computer program code. The computer program code may be in the form of source code, object code, and an executable file, some intermediate forms, or the like. The computer-readable medium may include any entity or apparatus capable of carrying the computer program code, a recording medium, a USB flash disk, a mobile hard disk, a magnetic disk, an optical disk, a computer memory, a read-only memory (ROM), a random access memory (RAM), an electric carrier signal, a telecommunication signal, a software distribution medium, and the like.

It is to be noted that, for brief description, the foregoing method embodiments are represented as a series of actions. However, it is to be appreciated by a person skilled in the art that the embodiments of the present invention are not limited to the described order of the actions, because some steps may be performed in other orders or simultaneously according to the embodiments of the present invention. Next, it is also to be appreciated by a person skilled in the art that the embodiments described in the specification all belong to preferred embodiments and the actions and modules involved are not necessarily required for the embodiments of the present invention.

In the foregoing embodiments, the descriptions of the embodiments have respective emphasis. For a part that is not described in detail in an embodiment, reference may be made to the related descriptions of other embodiments.

In the description of the present invention, it is to be understood that orientation or location relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial direction”, “radial direction”, and “circumferential direction” are based on orientation or location relationships shown in the accompanying drawings, are merely to facilitate the description of the present invention and simplify the description, rather than indicating or implying that the indicated apparatus or element needs to have a particular orientation or be constructed and operated in a particular orientation, and therefore cannot be construed as a limitation on the present invention.

In addition, terms “first” and “second” are merely for the purpose of description, but cannot be construed as indicating or implying relative importance or implicitly specifying a quantity of technical features indicated. Therefore, features defined with “first” and “second” may explicitly or implicitly include at least one of the features. In the description of the present invention, “a plurality of” means at least two, for example, two and three, unless otherwise explicitly and specifically defined.

In the present invention, unless otherwise clearly specified and defined, terms such as “mounting”, “connected”, “connection”, and “fixed” are to be understood in a broad sense. For example, the connection may be a fixed connection, a detachable connection, or an integral connection; or may be a mechanical connection, or an electrical connection or communication with each other; or may be a direct connection, an indirect connection through an intermediary, or internal communication between two elements or interaction between two elements, unless otherwise specified explicitly. A person of ordinary skill in the art may understand the specific meanings of the foregoing terms in the present invention based on specific situations.

In the present invention, unless otherwise explicitly specified and defined, the first feature being “on” or “above” or “below” or “under” the second feature may mean that the first feature and the second feature are in direct contact, or the first feature and the second feature are in indirect contact through an intermediary. Moreover, the first feature being “over”, “above”, and “on” the second feature may mean that the first feature is directly above or obliquely above the second feature, or merely mean that the first feature is at a higher horizontal location than the second feature. The first feature being “below”, “under”, and “beneath” the second feature may mean that the first feature is under or obliquely below the second feature, or merely indicate that the first feature is at a lower horizontal location than the second feature.

In the present invention, the terms “an embodiment”, “some embodiments”, “an example”, “a specific example”, “some examples,” and the like mean that specific features, structures, materials, or characteristics described in combination with the embodiment(s) or example(s) are included in at least one embodiment or example of the present invention. In this specification, schematic descriptions of the above terms are not necessarily directed at the same embodiment or example. Besides, the specific features, the structures, the materials, or the characteristics that are described may be combined in proper manners in any one or more embodiments or examples. In addition, a person skilled in the art may integrate or combine different embodiments or examples described in this specification and features of the different embodiments or examples as long as they do not contradict each other.

Although the embodiments of the present invention have been shown and described above, it may be understood that the above embodiments are exemplary and not to be construed as a limitation on the present invention, and a person skilled in the art may make changes, modifications, replacements and variations to the above embodiments within the scope of the present invention.

1.-46. (canceled)

47. A goods box storage method, comprising:
controlling, based on a preset storage location of a target goods box, a robot to move to a preset location of the robot;
detecting a target marker to which the target goods box belongs, the target marker being a structural feature of at least one of a target shelving unit to which the target goods box belongs, a goods box adjacent to the target goods box, and a goods box on a shelving unit opposite to the target shelving unit;
determining a target storage location of the target goods box on the target shelving unit based on a location of the target marker; and
controlling, based on the target storage location, the robot to move from the preset location of the robot to store the target goods box on the target shelving unit.

48. The goods box storage method according to claim 47, wherein the detecting a target marker to which the target goods box belongs comprises at least one of:
detecting a code pattern on the target shelving unit to which the target goods box belongs, and determining the target storage location of the target goods box on the target shelving unit based on a location of the code pattern in a case that the code pattern is detected, or detecting the target marker to which the target goods box belongs in a case that the code pattern is not detected;
during detection of the target marker, a box placement task is canceled if the target marker does not match a preset box storage feature or the target marker is not detected.

49. The goods box storage method according to claim 47, wherein after the robot moves to the preset location of the robot or when the robot is moving toward the preset location of the robot, the target storage location is determined based on the location of the target marker.

50. The goods box storage method according to claim 47, further comprising at least one of:
detecting whether there is another goods box on the target storage location, and transmitting, to a server, information that another goods box exists on the target storage location if there is another goods box; and controlling the robot to cancel a box placement task, or reassigning a storage location to the target goods box, or controlling the robot to retrieve the another goods box and place the another goods box in another location;
detecting an actual placement location of the target goods box after the target goods box is placed on the target shelving unit; and comparing the actual placement location with the target storage location and determining a relative location error of the actual placement location relative to the target storage location, and controlling the robot to retrieve the target goods box and relocate the target goods box if the relative location error does not satisfy a preset error condition;
detecting space occupation information of the target shelving unit and transmitting the space occupation information of the target shelving unit to a server after the target goods box is placed on the target shelving unit.

51. The goods box storage method according to claim 47, wherein the detecting a target marker to which the target goods box belongs in a case that the target marker is a goods box comprises:
obtaining a goods box image obtained by capturing an image of the target marker by a vision sensor;
performing edge detection on the goods box image to determine a plurality of edge line intersection points of the target marker, and performing contour detection on the goods box image to determine a plurality of contour vertices of the target marker;
checking the plurality of edge line intersection points and the plurality of contour vertices to determine a target vertex of the target marker; and
determining the location of the target marker based on the target vertex.

52. The goods box storage method according to claim 51, wherein the performing edge detection on the goods box image to determine a plurality of edge line intersection points of the target marker comprises:
performing edge detection on the goods box image to obtain a target edge detection image, wherein the target edge detection image comprises a plurality of edge lines of the target marker in the goods box image; and
identifying intersection points of the plurality of edge lines in the target edge detection image as the plurality of edge line intersection points of the target marker.

53. The goods box storage method according to claim 52, wherein the performing edge detection on the goods box image to obtain a target edge detection image comprises:
performing edge detection on the goods box image to obtain an initial edge detection image; and
fitting edge lines in the initial edge detection image to obtain the target edge detection image.

54. The goods box storage method according to claim 51, wherein the performing contour detection on the goods box image to determine a plurality of contour vertices of the target marker comprises:
performing contour detection on the goods box image to obtain a target contour detection image, wherein the target contour detection image comprises a contour of the target marker in the goods box image; and
identifying vertices of the contour in the target contour detection image as a plurality of contour vertices of the target marker.

55. The goods box storage method according to claim 54, wherein the performing contour detection on the goods box image to obtain a target contour detection image comprises:
performing contour detection on the goods box image to obtain an initial contour detection image; and
fitting contours in the initial contour detection image to obtain the target contour detection image.

56. The goods box storage method according to claim 51, wherein the checking the plurality of edge line intersection points and the plurality of contour vertices to determine a target vertex of the target marker comprises:
determining a first edge line intersection point and a first contour vertex at a same location;
obtaining pixel information of each first pixel point within a preset range of the first edge line intersection points and pixel information of each second pixel point within a preset range of the first contour vertices; and
determining the target vertex of the target marker based on the pixel information of each first pixel point and the pixel information of each second pixel point.

56. The goods box storage method according to claim 55, wherein the determining a first edge line intersection point and a first contour vertex at a same location comprises:
identifying a preset identifier in the goods box image, wherein the preset identifier is arranged at each vertex of the target marker in advance;
calculating a first distance between each of the plurality of edge line intersection points and the preset identifier, and a second distance between each of the plurality of contour vertices and the preset identifier; and
determining, based on the first distance and the second distance, the first edge line intersection point and the first contour vertex at the same location.

58. The goods box storage method according to claim 55, wherein the determining the target vertex of the target marker based on the pixel information of each first pixel point and the pixel information of each second pixel point comprises:
determining a first pixel gray level distribution within the preset range of the first edge line intersection points based on the pixel information of each first pixel point, and determining a second pixel gray level distribution within the preset range of the first contour vertices based on the pixel information of each second pixel point;
determining, from the first pixel gray level distribution and the second pixel gray level distribution, a target pixel gray level distribution that is consistent with a preset distribution rule; and
determining the target vertex of the target marker from the first edge line intersection point and the first contour vertex based on the target pixel gray level distribution.

59. The goods box storage method according to claim 51, wherein a contour shape of the target marker is a quadrilateral; and
the determining the location of the target marker based on the target vertex comprises:
obtaining vertex information of any three target vertices from four target vertices of the target marker; and
calculating, based on the vertex information of the three target vertices, pose information of the target marker relative to the vision sensor by using a preset perspective projection algorithm.

60. The goods box storage method according to claim 59, wherein after the calculating, based on the vertex information of the three target vertices, pose information of the target marker relative to the vision sensor by using a preset perspective projection algorithm, the method further comprises:
projecting a remaining target vertex among the four target vertices in addition to the three target vertices onto the goods box image based on the pose information, to obtain projection coordinates of the remaining target vertex;
obtaining vertex coordinates of the remaining target vertex in the goods box image;
calculating an error value based on the projection coordinates and the vertex coordinates;
updating the pose information based on the error value, and repeating the step of projecting the remaining target vertex among the four target vertices in addition to the three target vertices onto the goods box image based on the pose information, to obtain the projection coordinates of the remaining target vertex; and
determining that an updated pose information is target pose information of the target marker relative to the vision sensor in a case that the error value is less than or equal to a preset threshold.

61. The goods box storage method according to claim 47, wherein when a first target goods box is placed on the target shelving unit, the target marker is a structural feature of the target shelving unit.

62. A robot, comprising:
a robot body;
a retrieval and storage mechanism, arranged on the robot body;
a control unit, configured to control, based on a preset storage location of a target goods box, a robot to move to a preset location of the robot; and
a detection unit, arranged on the retrieval and storage mechanism and configured to detect a target marker to which the target goods box belongs, the target marker being a structural feature of at least one of a target shelving unit to which the target goods box belongs, a goods box adjacent to the target goods box, and a goods box on a shelving unit opposite to the target shelving unit, wherein
the control unit is further configured to determine a target storage location of the target goods box based on a location of the target marker, and control, based on the target storage location, the robot to move to cause the retrieval and storage mechanism to store the target goods box on the target shelving unit.

63. The robot according to claim 62, wherein the detection unit is configured to detect a code pattern on the target shelving unit to which the target goods box belongs, and determine the target storage location of the target goods box on the target shelving unit based on a location of the code pattern in a case that the detection unit detects the code pattern, or detect the target marker to which the target goods box belongs in a case that the code pattern is not detected.

64. The robot according to any of claim 62, wherein the control unit is configured to control, based on a preset storage location of the target goods box, the robot body to move to a first horizontal location, and control the retrieval and storage mechanism to move to a first height location.

65. The robot according to claim 62, wherein the control unit is further configured to:
control the retrieval and storage mechanism to move to the first height location after the robot body moves to the first horizontal location or when the robot body is moving toward the first horizontal location; or
control the retrieval and storage mechanism to move to a second height location lower than the first height location before the robot body moves to the first horizontal location, and control the retrieval and storage mechanism to move from the second height location to the first height location after the robot body moves to the first horizontal location.

66. A computer-readable storage medium, having a computer-executable instruction stored therein, the computer-executable instruction, when executed by a processor, implementing the method according to claim 47.
